(19) United States
(12) Patent Application Publication
(10) Pub. No.: US 2006/0203724 A1
(43) Pub. Date: Sep. 14, 2006

(54) Multi-carrier, multi-flow, reverse link medium access control for a communication system

(76) Inventors: Donna Ghosh, San Diego, CA (US); Christopher Gerard Lott, San Diego, CA (US); Rashid A. Attar, San Diego, CA (US)

Correspondence Address: QUALCOMM INCORPORATED, 5775 MOREHOUSE DR., SAN DIEGO, CA, 92121, US

(21) Appl. No.: 11/371,274

(22) Filed: Mar. 7, 2006

Related U.S. Application Data
(60) Provisional application No. 60/659,989, filed on Mar. 8, 2005.

(51) Int. Cl. H04J 3/22; H04L 1/00; H04J 3/16; H04Q 7/24; H04Q 7/00; H04L 12/26

(52) U.S. Cl. 370/229; 370/469; 370/328; 370/338

(57) ABSTRACT

The present method and apparatus comprises a communication element comprising a MAC layer that is configured for wireless communication within a sector, wherein said communication element comprises a transmitter, a receiver operably connected to the transmitter, a processor operably connected to the transmitter and the receiver, and memory operably connected to the processor, wherein the communication element is adapted to police data flow, whereby a peak data outflow constraint is applied for each flow across all assigned carriers, select a carrier from a plurality of the assigned carriers for the data flow, and control flow access, whereby a potential allowed transmission power for the data flow on the carrier is determined.

### BACKGROUND

This application claims benefit of U.S. Provisional Application titled “Multi-Carrier, Multi-Flow, Reverse Link Medium Access Control for a Communication System”, Application No. 60/659,989, filed Mar. 8, 2005, the entire disclosure of this application being considered part of the disclosure of this application.

### FIELD

The present invention relates generally to wireless communications systems, and more specifically, to improvements in the operation of a medium access control (MAC) layer of a system element such as an access terminal and an access network in a wireless communication system.

### BACKGROUND

Communication systems have been developed to allow transmission of information signals from an origination station to a physically distinct destination station. In transmitting an information signal from the origination station over a communication channel, the information signal is first converted into a form suitable for efficient transmission over the communication channel. Conversion, or modulation, of the information signal involves varying a parameter of a carrier wave in accordance with the information signal in such a way that the spectrum of the resulting modulated carrier is confined within the communication channel bandwidth. At the destination station the original information signal is replicated from the modulated carrier wave received over the communication channel. Such a replication is generally achieved by using an inverse of the modulation process employed by the origination station.

Modulation also facilitates multiple-access, i.e., simultaneous transmission and/or reception, of several signals over a common communication channel. Multiple-access communication systems often include a plurality of remote subscriber units requiring intermittent service of relatively short duration rather than continuous access to the common communication channel. Several multiple-access techniques are known in the art, such as code division multiple-access (CDMA), time division multiple-access (TDMA), frequency division multiple-access (FDMA), and amplitude modulation multiple-access (AM).

A multiple-access communication system may be a wireless or wire-line and may carry voice and/or data. In a multiple-access communication system, communications between users are conducted through one or more base stations. A first user on one subscriber station communicates to a second user on a second subscriber station by transmitting data on a reverse link to a base station. The base station receives the data and may route the data to another base station. The data is transmitted on a forward channel of the same base station, or the other base station, to the second subscriber station. The forward channel refers to transmission from a base station to a subscriber station and the reverse channel refers to transmission from a subscriber station to a base station. Likewise, the communication may be conducted between a first user on one mobile subscriber station and a second user on a landline station. A base station receives the data from the user on a reverse channel, and routes the data through a public switched telephone network (PSTN) to the second user. In many communication systems, e.g., IS-95, W-CDMA, IS-2000, the forward channel and the reverse channel are allocated separate frequencies.

An example of a data optimized communication system is a high data rate (HDR) communication system. In an HDR communication system, the base station is sometimes referred to as an access network (AN), and the remote station is sometimes referred to as an access terminal (AT). Functionality performed by an AT may be organized as a stack of layers, including a medium access control (MAC) layer. The AN may also include a MAC layer. The MAC layer offers certain services to higher layers, including services that are related to the operation of the reverse channel. Benefits may be realized by improvements in the operation of a MAC layer of an AT, or other communication element such as an AN, in a wireless communication system.

### SUMMARY

In one embodiment, the present apparatus comprises a communication element comprising a MAC layer that is configured for wireless communication within a sector, wherein said communication element comprises a transmitter, a receiver operably connected to the transmitter, a processor operably connected to the transmitter and the receiver, and memory operably connected to the processor, wherein the communication element is adapted to police data flow, whereby a peak data outflow constraint is applied for each flow across all assigned carriers, select a carrier from a plurality of the assigned carriers for the data flow, and control flow access, whereby a potential allowed transmission power for the data flow on the carrier is determined.

In another embodiment, the present method allocates resources among multiple flows transmitted across multiple carriers, by policing data flow, whereby a peak data outflow constraint is applied for each flow across all assigned carriers, selecting a carrier from a plurality of assigned carriers for the data flow, and control flow access, whereby a potential allowed transmission power for the data flow on the carrier is determined.

### BRIEF DESCRIPTION OF THE DRAWINGS

FIG. 1 illustrates an example of a communications system that supports a number of users and is capable of implementing at least some aspects of the embodiments discussed herein;

FIG. 2 is a block diagram illustrating an access network and an access terminal in a high data rate communication system;

FIG. 3 is a block diagram illustrating a stack of layers on an access terminal;

FIG. 4 is a block diagram illustrating exemplary interaction between higher layers on an access terminal, the medium access control layer, and the physical layer;

FIG. 5A is a block diagram illustrating a high capacity packet being transmitted to the access network;

FIG. 5B is a block diagram illustrating a low latency packet being transmitted to the access network;

FIG. 6 is a block diagram illustrating different types of flows that may exist on an access network;

FIG. 7 is a block diagram illustrating an exemplary flow set for a high capacity packet;

FIG. 8 is a block diagram illustrating an exemplary flow set for a low latency packet;

FIG. 9 is a block diagram illustrating information that may be maintained at an access terminal in order to determine whether a high capacity flow is included in the flow set of a low latency packet;

FIG. 10 is a block diagram illustrating an access network and a plurality of access terminals within a sector;

FIG. 11 illustrates an exemplary mechanism that may be used to determine the total available power for an access terminal;

FIG. 12 is a block diagram illustrating an embodiment in which at least some of the access terminals within a sector include multiple flows;

FIG. 13 is a block diagram illustrating one way in which the access terminal may obtain the current power allocation for the flows on the access terminal;

FIG. 14 is a block diagram illustrating a reverse activity bit being transmitted from the access network to the access terminals within a sector;

FIG. 15 is a block diagram illustrating information that may be maintained at the access terminal in order to determine the current power allocation for one or more flows on the access terminal;

FIG. 16 is a functional block diagram illustrating exemplary functional components in an access terminal that may be used to determine an estimate of the reverse activity bit and an estimate of the current loading level of the sector;

FIG. 17 is a flow diagram illustrating an exemplary method for determining the current power allocation for a flow on the access terminal;

FIG. 18 is a block diagram illustrating an access terminal sending a request message to a scheduler on the access network;

FIG. 19 is a block diagram illustrating information that may be maintained at the access terminal in order for the access terminal to determine when to send a request message to the access network;

FIG. 20 is a block diagram illustrating an exemplary interaction between a scheduler running on the access network and the access terminals within the sector;

FIG. 21 is a block diagram illustrating another exemplary interaction between a scheduler running on the access network and an access terminal;

FIG. 22 is a block diagram illustrating another embodiment of a grant message that is transmitted from the scheduler on the access network to the access terminal;

FIG. 23 is a block diagram illustrating a power profile that may be stored at the access terminal;

FIG. 24 is a block diagram illustrating a plurality of transmission conditions that may be stored at the access terminal;

FIG. 25 is a flow diagram illustrating an exemplary method that the access terminal may perform in order to determine the payload size and the power level for a packet;

FIG. 26 is a functional block diagram illustrating an embodiment of an access terminal;

FIG. 27 illustrates an example of decoupling flow access control from flow data policing at the access terminal by using two separate sets of token buckets for each MAC layer flow;

FIG. 28 is a flowchart illustrating the steps executed when policing flow data in the RTC MAC layer;

FIG. 29 is a block diagram illustrating an access terminal sending a carrier request message to a scheduler on the access network and receiving a carrier grant message;

FIG. 30 is a functional block diagram illustrating an example of decoupling flow access control from flow data policing at the access terminal by using two separate sets of token buckets for each MAC layer flow;

FIG. 31 is a functional block diagram illustrating an exemplary interaction between a scheduler running on the access network and the access terminals within the sector;

FIG. 32 is a functional block diagram illustrating an exemplary method for determining the current power allocation for a flow on the access terminal; and

FIG. 33 is a functional block diagram illustrating an access terminal sending a carrier request message to a scheduler on the access network and receiving a carrier grant message.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Note that the exemplary embodiment is provided as an exemplar throughout this discussion; however, alternate embodiments may incorporate various aspects without departing from the scope of the present invention. Specifically, the present invention is applicable to a multi-carrier, data processing system, a multi-carrier, wireless communication system, a multi-carrier, mobile IP network and any other system desiring to receive and process a wireless signal.

The exemplary embodiment employs a spread-spectrum wireless communication system. Wireless communication systems are widely deployed to provide various types of communication such as voice, data, and so on. These systems may be based on code division multiple access (CDMA), time division multiple access (TDMA), or some other modulation techniques. A CDMA system provides certain advantages over other types of systems, including increased system capacity.

A wireless communication system may be designed to support one or more standards such as the “TIA/EIA/IS-95-B Mobile Station-Base Station Compatibility Standard for Dual-Mode Wideband Spread Spectrum Cellular System” referred to herein as the IS-95 standard, the standard offered by a consortium named “3rd Generation Partnership Project” referred to herein as 3GPP, and embodied in a set of documents including Document Nos. 3GPP TS 25.211, 3GPP TS 25.212, 3GPP TS 25.213, and 3GPP TS 25.214, 3GPP TS 25.302, referred to herein as the W-CDMA standard, the standard offered by a consortium named “3rd Generation Partnership Project 2” referred to herein as 3GPP2, and TR-45.5 referred to herein as the CDMA2000 standard, formerly called IS-2000 MC. The standards cited hereinabove are hereby expressly incorporated herein by reference.

The systems and methods described herein may be used with high data rate (HDR) communication systems. A HDR communication system may be designed to conform to one or more standards such as the “cdma2000 High Rate Packet Data Air Interface Specification,” 3GPP2 C.S0024-A, Version 1, March 2004, promulgated by the consortium “3rd Generation Partnership Project 2.” The contents of the aforementioned standard are incorporated by reference herein.

A HDR subscriber station, which may be referred to herein as an access terminal (AT), may be mobile or stationary, and may communicate with one or more HDR base stations, which may be referred to herein as modem pool transceivers (MPTs). An access terminal (AT) transmits and receives data packets through one or more modem pool transceivers to an HDR base station controller, which may be referred to herein as a modem pool controller (MPC). Modem pool transceivers and modem pool controllers are parts of a network called an access network. An access network transports data packets between multiple access terminals. The access network may be further connected to additional networks outside the access network, such as a corporate intranet or the Internet, and may transport data packets between each access terminal (AT) and such outside networks. An access terminal (AT) that has established an active traffic channel connection with one or more modem pool transceivers is called an active access terminal, and is said to be in a traffic state. An access terminal (AT) that is in the process of establishing an active traffic channel connection with one or more modem pool transceivers is said to be in a connection setup state. An access terminal (AT) may be any data device that communicates through a wireless channel or through a wired channel, for example using fiber optic or coaxial cables. An access terminal (AT) may further be any of a number of types of devices including but not limited to PC card, compact flash, external or internal modem, or wireless or landline phone. The communication channel through which the access terminal (AT) sends signals to the modem pool transceiver is called a reverse channel. The communication channel through which a modem pool transceiver sends signals to an access terminal (AT) is called a forward channel.

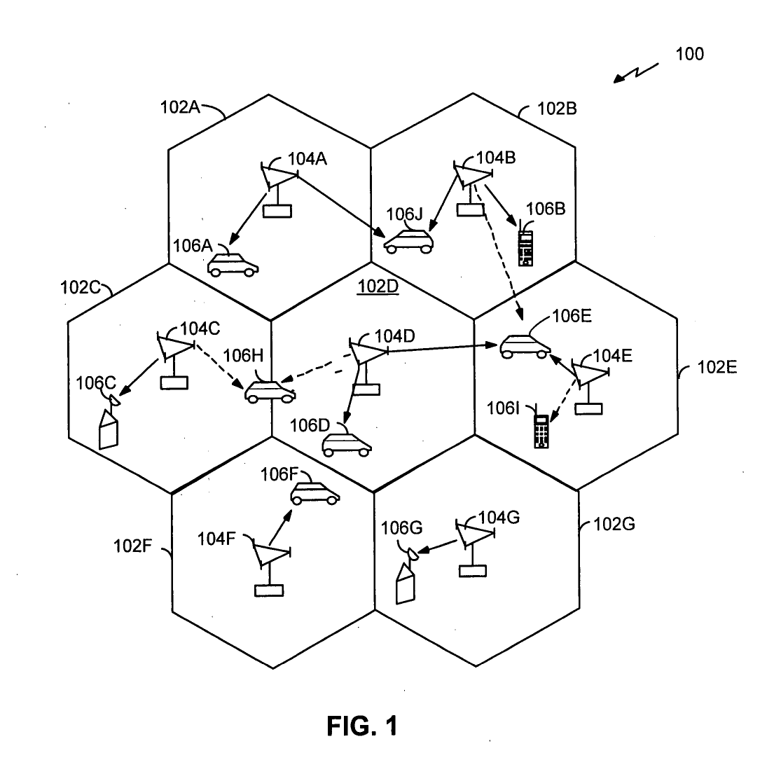

FIG. 1 illustrates an example of a communications system 100 that supports a number of users and is capable of implementing at least some aspects of the embodiments discussed herein. Any of a variety of algorithms and methods may be used to schedule transmissions in system 100. System 100 provides communication for a number of cells 102A-102G, each of which is serviced by a corresponding base station 104A-104G, respectively. In the exemplary embodiment, some of the base stations 104 have multiple receive antennas and others have only one receive antenna. Similarly, some of the base stations 104 have multiple transmit antennas, and others have single transmit antennas. There are no restrictions on the combinations of transmit antennas and receive antennas. Therefore, it is possible for a base station 104 to have multiple transmit antennas and a single receive antenna, or to have multiple receive antennas and a single transmit antenna, or to have both single or multiple transmit and receive antennas.

Remote stations 106 in the coverage area may be fixed (i.e., stationary) or mobile. As shown in FIG. 1, various remote stations 106 are dispersed throughout the system. Each remote station 106 communicates with at least one and possibly more base stations 104 on the forward channel and the reverse channel at any given moment depending on, for example, whether soft handoff is employed or whether the terminal is designed and operated to (concurrently or sequentially) receive multiple transmissions from multiple base stations. Soft handoff in CDMA communications systems is well known in the art and is described in detail in U.S. Pat. No. 5,101,501, entitled “Method and System for Providing a Soft Handoff in a CDMA Cellular Telephone System,” which is assigned to the assignee of the present invention.

The forward channel refers to transmission from the base station 104 to the remote station 106, and the reverse channel refers to transmission from the remote station 106 to the base station 104. In the exemplary embodiment, some of the remote stations 106 have multiple receive antennas and others have only one receive antenna. In FIG. 1, base station 104A transmits data to remote stations 106A and 106J on the forward channel, base station 104B transmits data to remote stations 106B and 106J on the forward channel, base station 104C transmits data to remote station 106C on the forward channel, and so on.

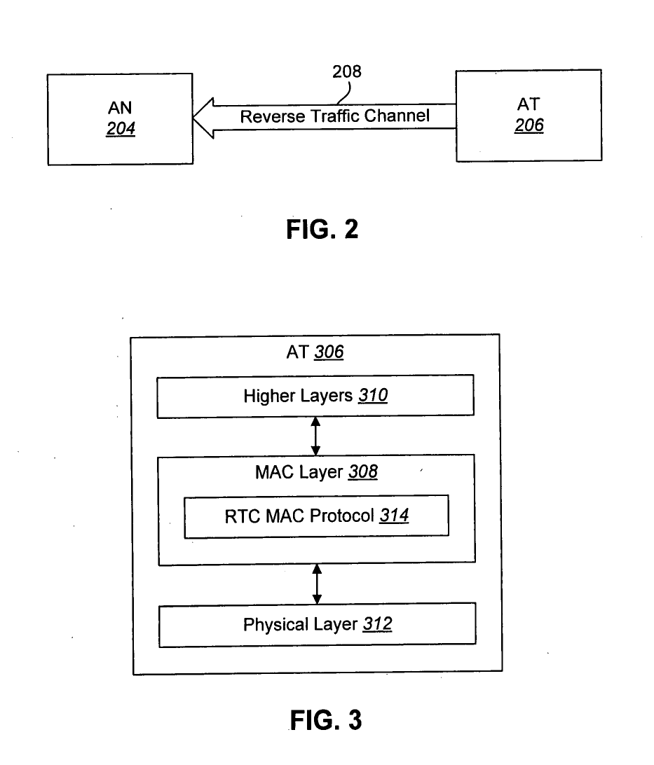

In a high data rate (HDR) communication system, the base station 104 is sometimes referred to as an access network (AN), and the remote station 106 is sometimes referred to as an access terminal (AT). FIG. 2 illustrates an AN 204 and an AT 206 in an HDR communication system.

The AT 206 is in wireless communication with the AN 204. As indicated previously, the reverse channel refers to transmissions from the AT 206 to the AN 204. The reverse traffic channel 208 is shown in FIG. 2. The reverse traffic channel 208 is the portion of the reverse channel that carries information from a specific AT 206 to the AN 204. Of course, the reverse channel may include other channels in addition to the reverse traffic channel 208. Also, the forward channel may include a plurality of channels, including a pilot channel.

Functionality performed by the AT 206 may be organized as a stack of layers. FIG. 3 illustrates a stack of layers on the AT 306. Among the layers is a medium access control (MAC) layer 308. Higher layers 310 are located above the MAC layer 308. The MAC layer 308 offers certain services to the higher layers 310, including services that are related to the operation of the reverse traffic channel 208. The MAC layer 308 includes an implementation of the reverse traffic channel (RTC) MAC protocol 314. The RTC MAC protocol 314 provides the procedures followed by the AT 306 to transmit, and by the AN 204 to receive, the reverse traffic channel 208.

A physical layer 312 is located below the MAC layer 308. The MAC layer 308 requests certain services from the physical layer 312. These services are related to the physical transmission of packets to the AN 204.

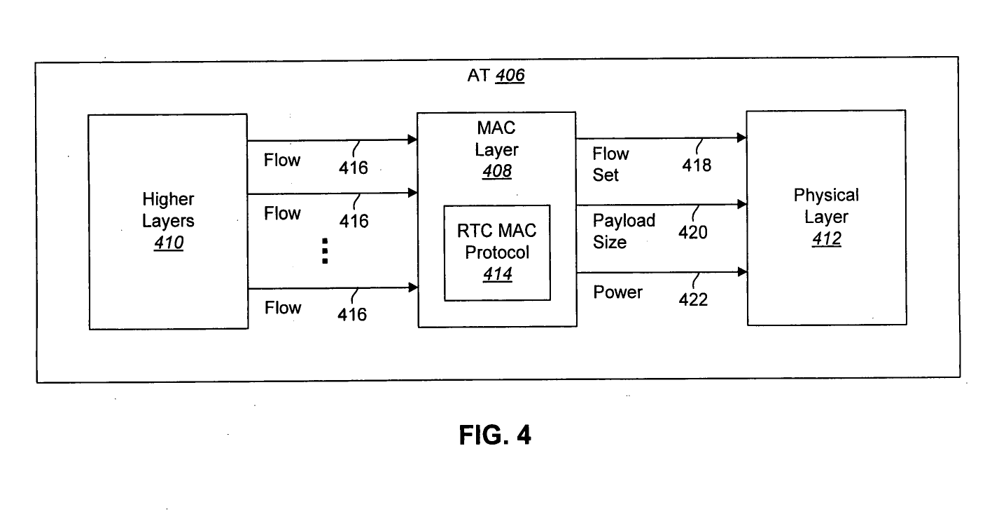

FIG. 4 illustrates exemplary interaction between the higher layers 410 on the AT 406, the MAC layer 408, and the physical layer 412. As shown, the MAC layer 408 receives one or more flows 416 from the higher layers 410. A flow 416 is a stream of data from a user source, with some set of transmission requirements, usually associated with some particular application. Typically, a flow 416 corresponds to a specific application, such as voice over IP (VoIP), videotelephony, file transfer protocol (FTP), gaming, etc.

Data from the flows 416 on the AT 406 is transmitted to the AN 204 in packets. In accordance with the RTC MAC protocol 414, the MAC layer determines a flow set 418 for each packet. Sometimes multiple flows 416 on the AT 406 have data to transmit at the same time. A packet may include data from more than one flow 416. However, sometimes there may be one or more flows 416 on the AT 406 that have data to transmit, but that are not included in a packet. The flow set 418 of a packet indicates the flows 416 on the AT 406 that are to be included in that packet. Exemplary methods for determining the flow set 418 of a packet will be described below.

The MAC layer 408 also determines the payload size 420 of each packet. The payload size 420 of a packet indicates how much data from the flow set 418 is included in the packet.

The MAC layer 408 also determines the power level 422 of the packet. In some embodiments, the power level 422 of the packet is determined relative to the power level of the reverse pilot channel.

For each packet that is transmitted to the AN 204, the MAC layer 408 communicates the flow set 418 to be included in the packet, the payload size 420 of the packet, and the power level 422 of the packet to the physical layer 412. The physical layer 412 then effects transmission of the packet to the AN 204 in accordance with the information provided by the MAC layer 308.

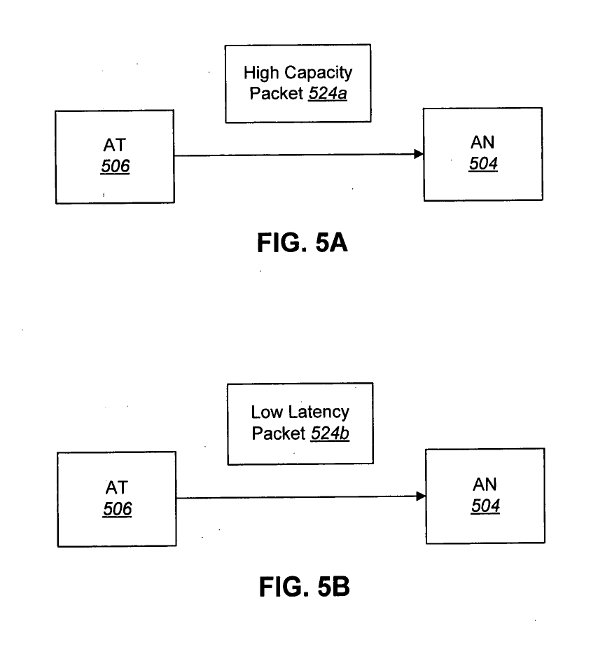

FIGS. 5A and 5B illustrate packets 524 being transmitted from the AT 506 to the AN 504. A packet 524 may be transmitted in one of several possible transmission modes (TM). For example, in some embodiments there are two possible transmission modes, a high capacity transmission mode and a low latency transmission mode. FIG. 5A illustrates a high capacity packet 524a (i.e., a packet 524a that is transmitted in high capacity mode) being transmitted to the AN 504. FIG. 5B illustrates a low latency packet 524b (i.e., a packet 524b that is transmitted in low latency mode) being transmitted to the AN 504.

Data from delay-sensitive flows (LoLat flows) are typically sent using the Low Latency (LoLat) transmission mode. Data from delay-tolerant flows (HiCap flows) are usually sent using the High Capacity (HiCap) transmission mode. A low latency packet 524b is transmitted at a higher power level 422 than a high capacity packet 524a of the same packet size. Therefore, it is probable that a low latency packet 524b will arrive more quickly at the AN 504 than a high capacity packet 524a. However, a low latency packet 524b causes more loading on the system 100 than a high capacity packet 524a.

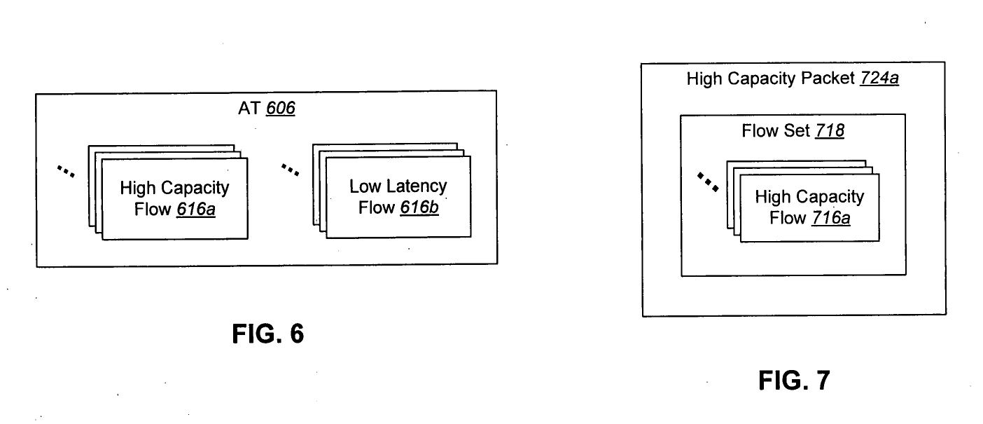

FIG. 6 illustrates different types of flows 616 that may exist on an AT 606. In some embodiments, each flow 616 on an AT 606 is associated with a particular transmission mode. Where the possible transmission modes are a high capacity transmission mode and a low latency transmission mode, an AT 606 may include one or more high capacity flows 616a and/or one or more low latency flows 616b. It is preferable for a high capacity flow 616a to be transmitted in a high capacity packet 524a. It is preferable for a low latency flow 616b to be transmitted in a low latency packet 524b.

FIG. 7 illustrates an exemplary flow set 718 for a high capacity packet 724a. In some embodiments, a packet 724a is transmitted in high capacity mode only if all of the flows 716 that have data to transmit are high capacity flows 716a. Accordingly, in such embodiments, the flow set 718 in a high capacity packet 724a only includes high capacity flows 716a. Alternatively, low latency flows 616b may be included in high capacity packets 724a, at the discretion of the AT 606. One exemplary reason to do this is when the low latency flow 616b is not getting enough throughput. For example, it might be detected that the queue of the low latency flow 616b is building up. The flow may improve its throughput by using high capacity mode instead, at the expense of increased latency.

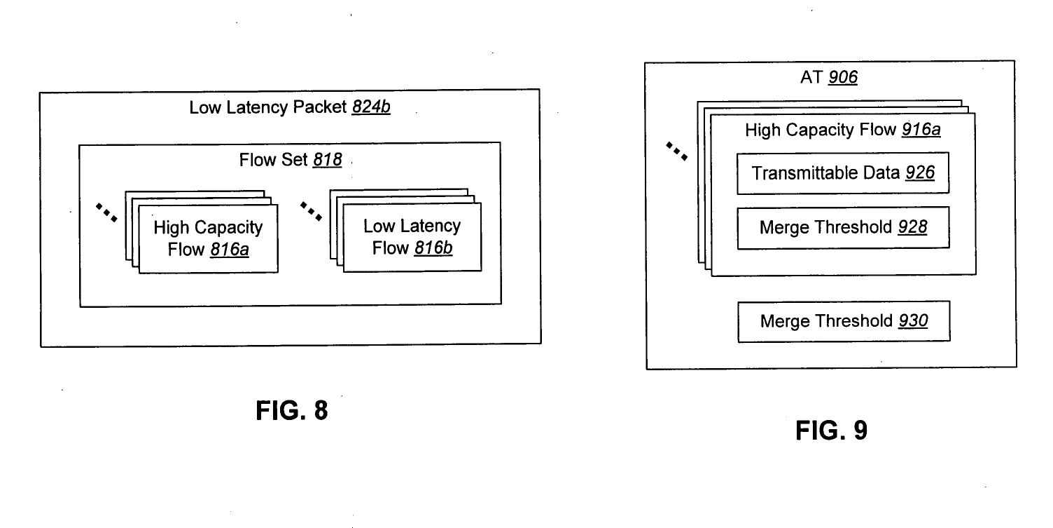

FIG. 8 illustrates an exemplary flow set 818 for a low latency packet 824b. In some embodiments, if there is at least one low latency flow 816b that has data to transmit, then the packet 824b is transmitted in low latency mode. The flow set 818 in a low latency packet 824b includes each low latency flow 816b that has data to transmit. One or more of the high capacity flows 816a that have data to transmit may also be included in the flow set 818. However, one or more of the high capacity flows 816a that have data to transmit may not be included in the flow set 818.

Merging Concurrent Low Latency and High Capacity Flows in a Physical Layer Packet in Each Reverse Link Carrier

Merging arises when an AT 906 contains multiple flows of different termination targets. Because each physical packet may have one termination target, rules may be used to determine when flows may be merged into the same packet. Rules for merging concurrent low latency and high capacity flows into a packet depend on the flow priorities and the sector loading. FIG. 9 illustrates information that may be maintained at the AT 906 in order to determine whether a high capacity flow 916a is included in the flow set 818 of a low latency packet 824b. Each high capacity flow 916a on the AT 906 has a certain amount of data 926 that is available for transmission. Also, a merge threshold 928 may be defined for each high capacity flow 916a on the AT 906. In addition, a merge threshold 930 may be defined for the AT 906 as a whole. Finally, a merging of high capacity flows may occur when an estimate of the loading level of the sector is less than a threshold value. (How the estimate of the loading level of the sector is determined will be discussed below.) That is, when the sector is sufficiently lightly loaded, the efficiency loss of merging is not important and aggressive usage is allowed.

In some embodiments, a high capacity flow 916a is included in a low latency packet 524b if either of two conditions is satisfied. The first condition is that the sum of the transmittable data 926 for all of the high capacity flows 916a on the AT 906 exceeds the merge threshold 930 that is defined for the AT 906. The second condition is that the transmittable data 926 for the high capacity flow 916a exceeds the merge threshold 928 that is defined for the high capacity flow 916a.

The first condition relates to the power transition from low latency packets 824b to high capacity packets 724a. If high capacity flows 916a are not included in low latency packets 824b, data from the high capacity flows 916a builds up as long as there is data available for transmission from at least one low latency flow 816b. If too much data from the high capacity flows 916a is allowed to accumulate, then the next time that a high capacity packet 724a is transmitted, there may be an unacceptably sharp power transition from the last low latency packet 824b to the high capacity packet 724a. Therefore, in accordance with the first condition, once the amount of transmittable data 926 from the high capacity flows 916a on the AT 906 exceeds a certain value (defined by the merge threshold 930), “merging” of data from the high capacity flows 916a into low latency packets 824b is allowed.

The second condition relates to the quality of service (QoS) requirements for the high capacity flows 916a on the AT 906. If the merge threshold 928 for a high capacity flow 916a is set to a very large value, this means that the high capacity flow 916a is rarely, if ever included in a low latency packet 824b. Consequently, such a high capacity flow 916a may experience transmission delays, because it is not transmitted whenever there is at least one low latency flow 816b with data to transmit. Conversely, if the merge threshold 928 for a high capacity flow 916a is set to a very small value, this means that the high capacity flow 916a is almost always included in a low latency packet 824b. Consequently, such high capacity flows 916a may experience very little transmission delay. However, such high capacity flows 916a use up more sector resources to transmit their data.

Advantageously, in some embodiments, the merge threshold 928 for some of the high capacity flows 916a on the AT 906 may be set to a very large value, while the merge threshold 928 for some other high capacity flows 916a on the AT 906 may be set to a very small merge threshold 928. Such a design is advantageous because some types of high capacity flows 916a may have strict QOS requirements, while others may not. An example of a flow 916 that has strict QOS requirements and that may be transmitted in high capacity mode is real-time video. Real-time video has a high bandwidth requirement, which may make it inefficient for transmission in low latency mode. However, arbitrary transmission delays are not desired for real-time video. An example of a flow 916 that does not have strict QOS delay requirements and that may be transmitted in high capacity mode is a best effort flow 916.

Setting Power Levels of Packets in a Given Reverse Link Carrier

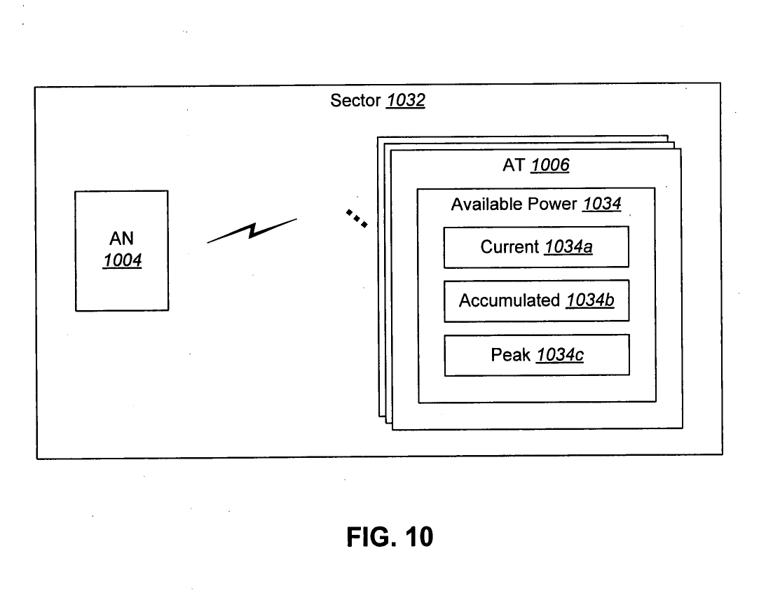

FIG. 10 illustrates an AN 1004 and a plurality of ATs 1006 within a sector 1032. A sector 1032 is a geographic region in which the signals from an AN 1004 may be received by an AT 1006, and vice versa.

One property of some wireless communication systems, such as CDM systems, is that transmissions interfere with each other. Therefore, to ensure that there is not too much interference between ATs 1006 within the same sector 1032, there is a limited amount of power received at the AN 1004 that the ATs 1006, collectively, may use. To ensure that the ATs 1006 stay within this limit, a certain amount of power 1034 is available to each AT 1006 within the sector 1032 for transmissions on the reverse traffic channel 208. Each AT 1006 sets the power level 422 of the packets 524 that it transmits on the reverse traffic channel 208 so as not to exceed its total available power 1034.

The power level 1034 that is allocated to an AT 1006 may not be exactly equal to the power level 422 that the AT 1006 uses to transmit packets 524 on the reverse traffic channel 208. For example, in some embodiments there is a set of discrete power levels that the AT 1006 selects from in determining the power level 422 of a packet 524. The total available power 1034 for an AT 1006 may not be exactly equal to any of the discrete power levels.

The total available power 1034 that is not used at any given time is allowed to accumulate, so that it may be used at a subsequent time. Thus, in such embodiments, the total available power 1034 for an AT 1006 is (roughly) equal to a current power allocation 1034a plus at least some portion of an accumulated power allocation 1034b. The AT 1006 determines the power level 422 of a packet 524 so that it does not exceed the total available power 1034 for the AT 1006.

The total available power 1034 for an AT 1006 may not always equal the AT's 1006 current power allocation 1034a plus the AT's 1006 accumulated power allocation 1034b. In some embodiments, the AT's 1006 total available power 1034 may be limited by a peak allocation 1034c. The peak allocation 1034c for an AT 1006 may be equal to the current power allocation 1034a for the AT 1006 multiplied by some limiting factor. For example, if the limiting factor is two, then the AT's 1006 peak allocation 1034c is equal to twice its current power allocation 1034a. In some embodiments, the limiting factor is a function of the current power allocation 1034a for the AT 1006.

Providing a peak allocation 1034c for the AT may limit how “bursty” the AT's 1006 transmissions are allowed to be. For example, it may occur that an AT 1006 does not have data to transmit during a certain period of time. During this period of time, power may continue to be allocated to the AT 1006. Because there is no data to transmit, the allocated power accumulates. At some point, the AT 1006 may suddenly have a relatively large amount of data to transmit. At this point, the accumulated power allocation 1034b may be relatively large. If the AT 1006 were allowed to use the entire accumulated power allocation 1034b, then the AT's 1006 transmitted power 422 may experience a sudden, rapid increase. However, if the AT's 1006 transmitted power 422 increases too rapidly, this may affect the stability of the system 100. Accordingly, the peak allocation 1034c may be provided for the AT 1006 to limit the total available power 1034 of the AT 1006 in circumstances such as this. Note that the accumulated power allocation 1034b is still available, but its use is spread out over more packets when the peak allocation 1034c is limited.

Policing Data Flow in a Single Reverse Link Carrier

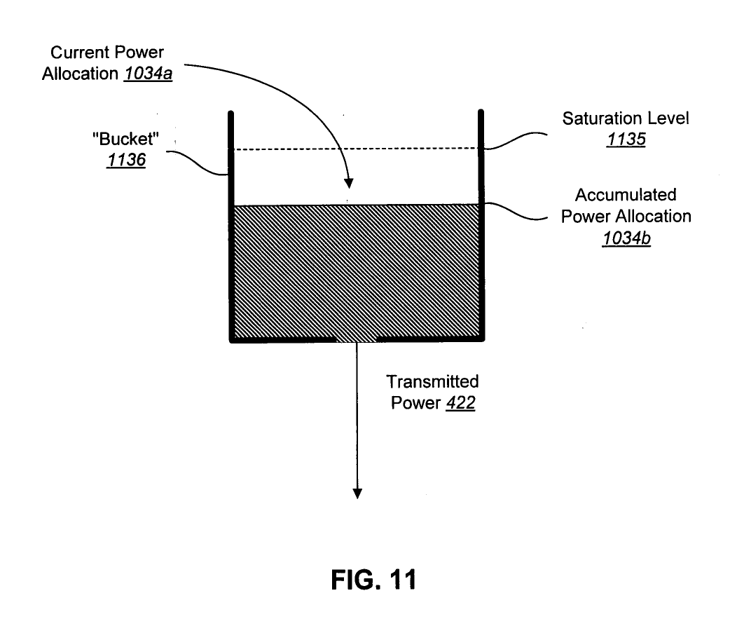

FIG. 11 illustrates an exemplary mechanism that may be used to determine the total available power 1034 for an AT 206. The mechanism involves the use of a virtual “bucket” 1136. This RLMAC bucket is used for each data flow to police data flow as well as control flow access. The data generated by an application flow is first regulated in the data domain. The policing function ensures that average and peak resources utilized by a flow is less than or equal to a limit. Policing data flow operates using the following method. At periodic intervals, a new current power allocation 1034a is added to the bucket 1136. Also at periodic intervals, the power level 422 of the packets 524 transmitted by the AT 206 exits the bucket 1136. The amount by which the current power allocation 1034a exceeds the power level 422 of the packets is the accumulated power allocation 1034b. The accumulated power allocation 1034b remains in the bucket 1136 until it is used.

The total power available 1034 minus the current power allocation 1034a is the total potential withdrawal from the bucket 1136. The AT 1006 ensures that the power level 422 of the packets 524 that it transmits does not exceed the total available power 1034 for the AT 1006. As indicated previously, under some circumstances the total available power 1034 is less than the sum of the current power allocation 1034a and the accumulated power allocation 1034b. For example, the total available power 1034 may be limited by the peak power allocation 1034c.

The accumulated power allocation 1034b may be limited by a saturation level 1135. In some embodiments, the saturation level 1135 is a function of an amount of time that the AT 1006 is permitted to utilize its peak power allocation 1034c. A bucket 1136 in excess of saturation level 1135 may indicate over allocation due to one of three reasons: i) PA headroom or data limit, ii) T2PInflow 1035 decays down to an AN 1004 controlled minimum value, or iii) T2Pflow 1035 starts increasing when flow is no longer over-allocated. T2PInflow 1035 is defined as the resource level in the network that is currently assigned to the flow. Thus, T2PInflow 1035=new resource inflow (long Term T2P resource based on AN 1004 assigned flow priority).

Flow Access Control by Allocating Resources Among the Multiple Flows Associated with AT 1206 in Each Reverse Link Carrier

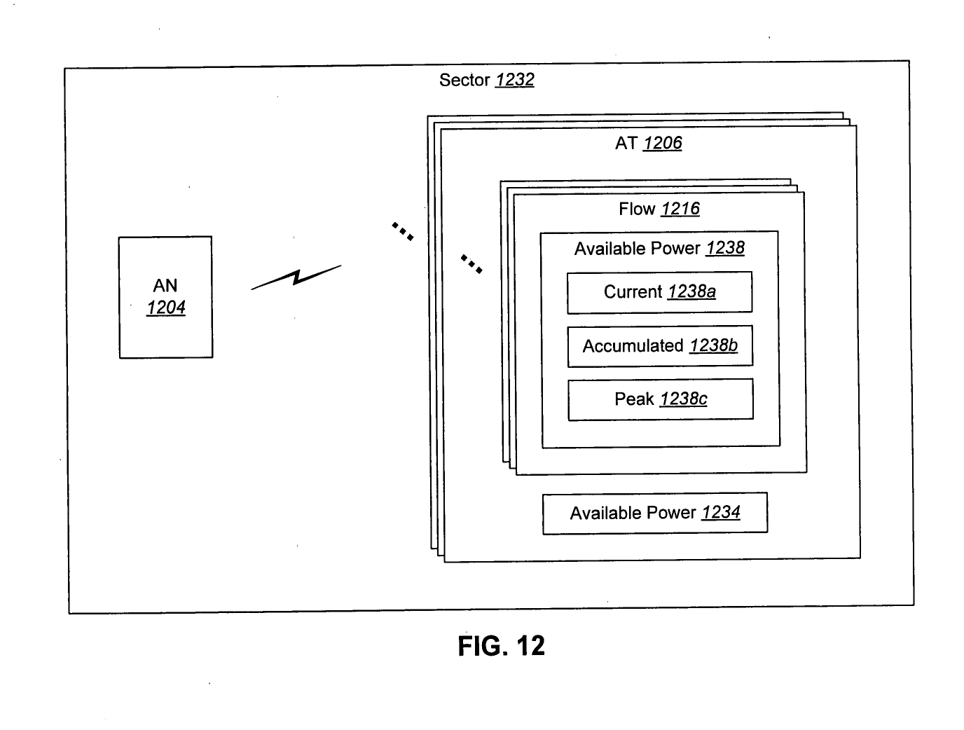

FIG. 12 illustrates an embodiment in which at least some of the ATs 1206 within a sector 1232 include multiple flows 1216. Resources among the multiple flows associated with the AT 1206 are allocated in a manner that maintains quality assurance (QoS). In such an embodiment, a separate amount of available power 1238 may be determined for each flow 1216 on the AT 1206. The power available 1238 for a flow 1216 on the AT 1206 may be determined in accordance with the methods described previously in connection with FIGS. 10-11. Each flow maintains a bucket for storing unused T2P resource, up to some maximum level. As flow data arrives, bucket resource is used to allocate packets, subject to a maximum bucket withdrawal rate based on peak-to-average access control. In this way, average resource usage is bounded by T2PInflow 1035, but locally bursty allocations can be made for data sources that benefit from them. Peak-to-average control, referred to as BucketFactor, restricts how bursty the AN 1004 received power can be from each flow.

More specifically, the total available power 1238 for a flow 1216 may include a current power allocation 1238a for the flow 1216 plus at least some portion of an accumulated power allocation 1238b for the flow 1216. In addition, the total available power 1238 for a flow 1216 may be limited by a peak allocation 1238c for the flow 1216. A separate bucket mechanism (which utilizes parameters BucketLevel and T2PInflow 1235 described below), such as that shown in FIG. 11, may be maintained for each flow 1216 in order to determine the total available power 1238 for each flow 1216. The total available power 1234 for the AT 1206 may be determined by taking the sum of the total available power 1238 for the different flows 1216 on the AT 1206.

The following provides a mathematical description of various formulas and algorithms that may be used in the determination of the total available power 1238 for a flow 1216 on the AT 1206. In the equations described below, the total available power 1238 for each flow i on the AT 1206 is determined once every sub-frame. (In some embodiments, a sub-frame is equal to four time slots, and a time slot is equal to 5/3 ms.) The total available power 1238 for a flow is referred to in the equations as PotentialT2POutflow.

The total available power 1238 for flow i transmitted in a high capacity packet 524a may be expressed as:

$$PotentialT 2 {POutflow}_{i , HC} = max ( 0 , min ( \begin{matrix}( 1 + AllocationStagger \times {r}_{n} ) \times ( \begin{matrix}( \frac{{BucketLevel}_{i , n}}{4} ) + \\ T 2 {PInflow}_{i , n}\end{matrix} ) , \\ BucketFactor ( T 2 {PInflow}_{i , n} , {FRAB}_{i , n} ) \times T 2 {PInflow}_{i , n}\end{matrix} ) ) \qquad ( 1 )$$

The total available power 1238 for flow i transmitted in a low latency packet 524b may be expressed as:

$$PotentialT 2 {POutflow}_{i , LL} = max ( 0 , min ( \begin{matrix}( 1 + AllocationStagger \times {r}_{n} ) \times ( \begin{matrix}( \frac{{BucketLevel}_{i , n}}{2} ) + \\ T 2 {PInflow}_{i , n}\end{matrix} ) , \\ BucketFactor ( T 2 {PInflow}_{i , n} , {FRAB}_{i , n} ) \times T 2 {PInflow}_{i , n}\end{matrix} ) ) \qquad ( 2 )$$

BucketLevel_{i,n} is the accumulated power allocation 1238b for flow i at sub-frame n. T2PInflow_{i,n} is the current power allocation 1238a for flow i at sub-frame n. The expression BucketFactor(T2PInflow_{i,n},FRAB_{i,n})×T2PInflow_{i,n} is the peak power allocation 1238c for flow i at sub-frame n. BucketFactor(T2PInflow_{i,n},FRAB_{i,n}) is a function for determining the limiting factor for the total available power 1238, i.e. the factor by which the total available power 1238 for flow i at sub-frame n is permitted to exceed the current power allocation 1238a for flow i at sub-frame n. Filtered Reverse Activity Bit flow i at sub-frame n (FRAB_{i,n}) is an estimate of the loading level of the sector 1232, and will be discussed in greater detail below. AllocationStagger is the amplitude of a random term that dithers allocation levels, to avoid synchronization problems, and rₙ is a real-valued uniformly distributed random number in the range [−1,1].

The accumulated power allocation 1238b for flow i at sub-frame n+1 may be expressed as:
BucketLevel_{i,n+1}=min((BucketLevel_{i,n}+T2PInflow_{i,n}−T2POutflow_{i,n}),BucketLevelSat_{i,n+1}) (3)

T2POutflow_{i.n} 425 is the portion of the transmitted power 422 that is apportioned to flow i at sub-frame n. An exemplary equation for T2POutflow_{i.n} is provided below. BucketLevelSat_{i,n+1} is the saturation level 1135 for the accumulated power allocation 1238b for flow i at sub-frame n+1. An exemplary equation for BucketLevelSat_{i,n+1} is provided below.

T2POutflow_{i,n} 425 may be expressed as:

$$T 2 {POutflow}_{i , n} = ( \frac{{d}_{i , n}}{{SumPayload}_{n}} ) \times TxT 2 {P}_{n} \qquad ( 4 )$$

In equation 4, d_{i,n} is the amount of data from flow i that is included in the sub-packet that is transmitted during sub-frame n. (A sub-packet is the portion of a packet that is transmitted during a sub-frame.) SumPayloadₙ is the sum of d_{i,n}. T×T2P represents a transmit traffic-to-pilot channel power ratio and T×T2Pₙ is the power level 422 of the sub-packet that is transmitted during sub-frame n.

BucketLevelSat_{i,n+1} may be expressed as:
BucketLevelSat_{i,n+1}=BurstDurationFactorᵢ×BucketFactor(T2PInflow_{i,n},FRAB_{i,n})×T2PInflow_{i,n} (5)

BurstDurationFactorᵢ is a limitation on the length of time that flow i is permitted to transmit at the peak power allocation 1238c.

Obtaining Current Power Allocation 1338a for Flows 1316 on AT 1306 from AN 1304 in a Given Reverse Link Carrier in a Given Reverse Link Carrier

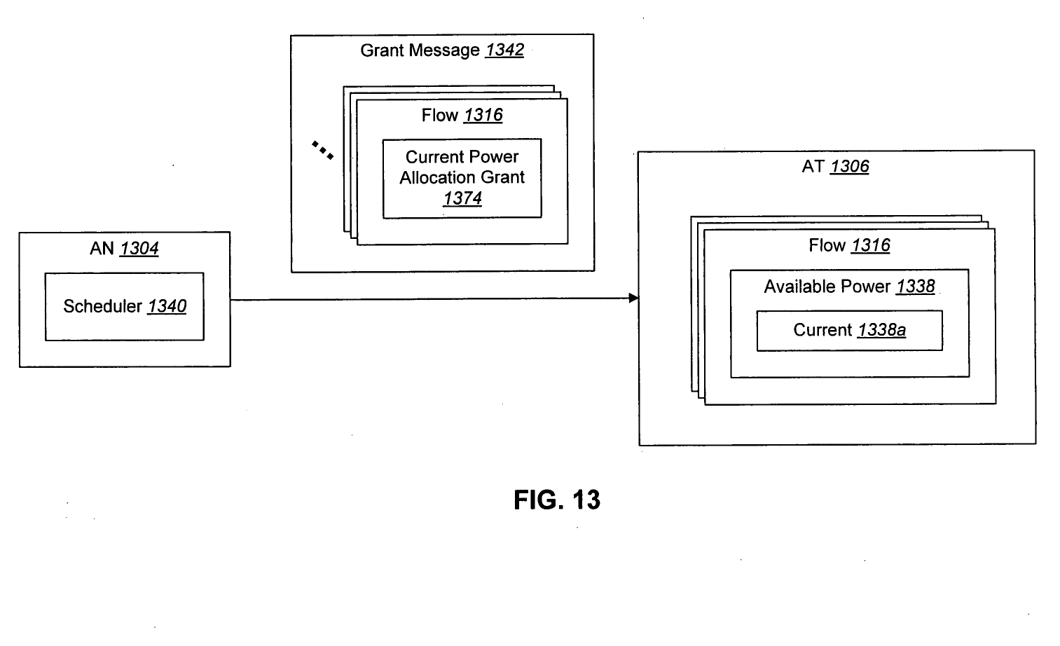

In some embodiments, obtaining the current power allocation 1338a may be a two-step process. Flow resources may either be allocated in a distributed fashion by each AT 1306 (autonomous mode) or from a central controller or scheduler 1340 located in an AN 1304 using a grant 1374. FIG. 13 illustrates one way in which the AT 1306 may obtain the current power allocation 1338a for the flows 1316 on the AT 1306 using a form of centralized control of network resource allocation by an AN 1304. As shown, the AT 1306 may receive a grant message 1342 from a scheduler 1340 that is running on the AN 1304. The grant message 1342 may include a current power allocation grant 1374 for some or all of the flows 1316 on the AT 1306. A grant 1374 is a resource allocation, and not a per-packet allocation, that allows the AN 1304 to provide resource allocation updates and changes. It allows for in-band signaling of detailed QoS information. For each current power allocation grant 1374 that is received, the AT 1306 sets the current power allocation 1338a for the corresponding flow 1316 equal to the current power allocation grant 1374. The grant 1374 allocates and freezes the power allocation for a time interval. Thus, the AN 1304 controls flow resource allocation during this time interval.

As stated above, flow resources can either be allocated in a distributed fashion by each AT 1306 (autonomous mode) or from a central controller or scheduler 1340 located in an AN 1304 using a grant 1374. Thus, the first step involves determining whether a current power allocation grant 1374 for a flow 1316 has been received from the AN 1304. If not, then the AT 1306 autonomously determines the current power allocation 1338a for the flow 1216. In other words, the AT 1306 determines the current power allocation 1338a for the flow 1216 without intervention from the scheduler 1340. This may be referred to as an autonomous mode. The following discussion relates to exemplary methods for the AT 1306 to autonomously determine the current power allocation 1338a for one or more flows 1316 on the AT 1306.

Autonomously Determining Current Power Allocations 1238a for One or More Flows 1216 in Each Reverse Link Carrier

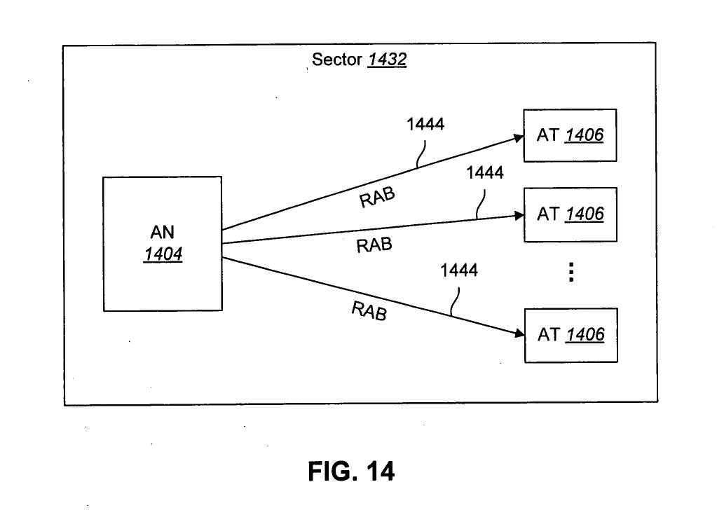

FIG. 14 illustrates a reverse activity bit (RAB) 1444 being transmitted from the AN 1404 to the ATs 1406 within a sector 1432. The access node 1404 uses the RAB to inform the ATs 1406 within its coverage area concerning the amount of current traffic activity over the reverse link. Thus, the RAB 1444 is an overload indication. ATs incorporate this information when deciding whether to decrease their traffic rates because of high traffic load over the reverse link or increase their traffic rates because of low traffic load over the reverse link. The RAB 1444 may be one of two values, a first value (e.g., +1) which indicates that the sector 1432 is presently busy, or a second value (e.g., −1) which indicates that the sector 1432 is presently idle. As will be explained below, the RAB 1444 may be used to determine the current power allocations 1238a for the flows 1216 on the AT 1206. Note that flows 1216, whether sharing an AT 1406 or across ATs 1406, see the same RAB 1444 in each sector. This is a design simplification that scales well in multiflow scenarios.

Autonomously Determining Current Power Allocation 1238a Using Short and Long RAB Estimates in Each Reverse Link Carrier

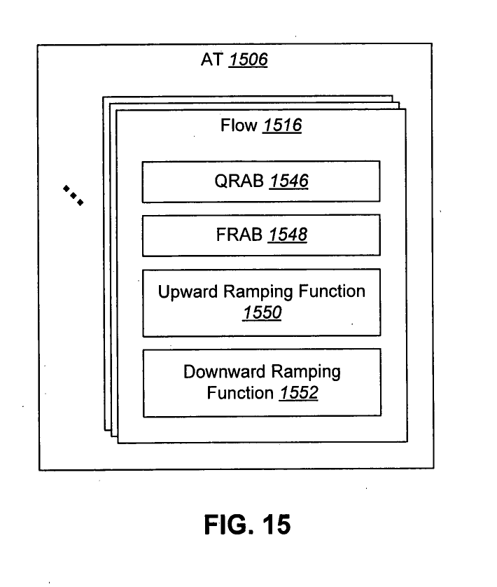

FIG. 15 illustrates information that may be maintained at the AT 1506 in order to determine the current power allocation 1238a for one or more flows 1516 on the AT 1506. In the illustrated embodiment, each flow 1516 is associated with a “quick” or “short term” estimate of the RAB 1444. This quick estimate will be referred to herein as QRAB 1546. An exemplary method for determining QRAB 1546 will be described below.

Each flow 1516 is also associated with an estimate of the longer-term loading level of the sector 1232, referred to herein as FRAB 1548 (which stands for “filtered” RAB 1444). FRAB is a measure of sector loading similar to QRAB 1546, but with a much longer time constant τ. Thus, QRAB is relatively instantaneous, whereas FRAB 1548 gives longer-term sector loading information. FRAB 1548 is a real number that lies somewhere between the two possible values of the RAB 1444, e.g., +1 and −1 in the present embodiment. However, other numbers can be used for values of the RAB 1444. The closer FRAB 1548 comes to the value of RAB 1444 which indicates that the sector 1432 is busy, the more heavily loaded the sector 1432 is. Conversely, the closer FRAB 1548 comes to the value of the RAB 1444 which indicates the sector 1432 is idle, the less heavily loaded the sector 1432 is. An exemplary method for determining FRAB 1548 will be described below.

Each flow 1516 is also associated with an upward ramping function 1550 and a downward ramping function 1552. The upward ramping function 1550 and the downward ramping function 1552 associated with a particular flow 1516 are functions of the current power allocation 1238a for the flow 1516. The upward ramping function 1550 associated with a flow 1516 is used to determine an increase in the current power allocation 1238a for the flow 1516. Conversely, the downward ramping function 1552 associated with a flow 1516 is used to determine a decrease in the current power allocation 1238a for the flow 1516. In some embodiments, both the upward ramping function 1550 and the downward ramping function 1552 depend on the value of FRAB 1548 and the current power allocation 1238a for the flow 1516. Since the upward ramping function 1550 and the downward ramping function 1552 depend on the value of FRAB, they are loading dependent ramping functions. Consequently, FRAB allows decoupling of unloaded T2P ramping dynamics from loaded steady-state T2P dynamics. When the sector is unloaded, faster ramping is desired to quickly and smoothly fill sector capacity. When the sector is loaded, slower ramping is desired to reduce Rise-over-Thermal (RoT) variation. The RoT at a sector is defined as the ratio of total received power to thermal noise power. This quantity is readily measurable and self-calibrating, and provides an estimate of the interference seen by each AT 1506. In the prior art, fixed ramping is used resulting in a tradeoff between these conflicting requirements.

The upward ramping function 1550 and the downward ramping function 1552 are defined for each flow 1516 in the network, and are downloadable from the AN 1404 controlling the flow's AT 1506. The upward ramping function and the downward ramping function have the flow's current power allocation 1238a as their argument. The upward ramping function 1550 will sometimes be referred to herein as gu, and the downward ramping function 1552 will sometimes be referred to herein as gd. We refer to the ratio of gu/gd (also a function of current power allocation 1238a) as a demand or priority function. It can be demonstrated that, subject to data and access terminal power availability, the reverse link MAC (RLMac) method converges to a current power allocation 1238a for each flow 1516 such that all flow demand function values are equal when taken at their flow's allocation. Using this fact, and carefully designing the flow demand functions, it is possible to achieve the same general mapping of flow layout and requirements to resource allocation as that achievable by a centralized scheduler. But the demand function method achieves this general scheduling capability with minimal control signaling and in a decentralized manner. The upward and downward ramping functions allow rapid traffic-to-pilot channel power (T2P) increases in lightly loaded sectors, smooth filing in of sector capacity, lower ramping as the sector load increases and decoupling of T2P dynamics between loaded and unloaded sectors. Here, T2P is used as a sector resource. For a fixed termination goal, T2P increases roughly linearly with flow transmission rate.

Components in AT 1506 Used to Determine QRAB 1646 and FRAB 1648 in Each Reverse Link Carrier

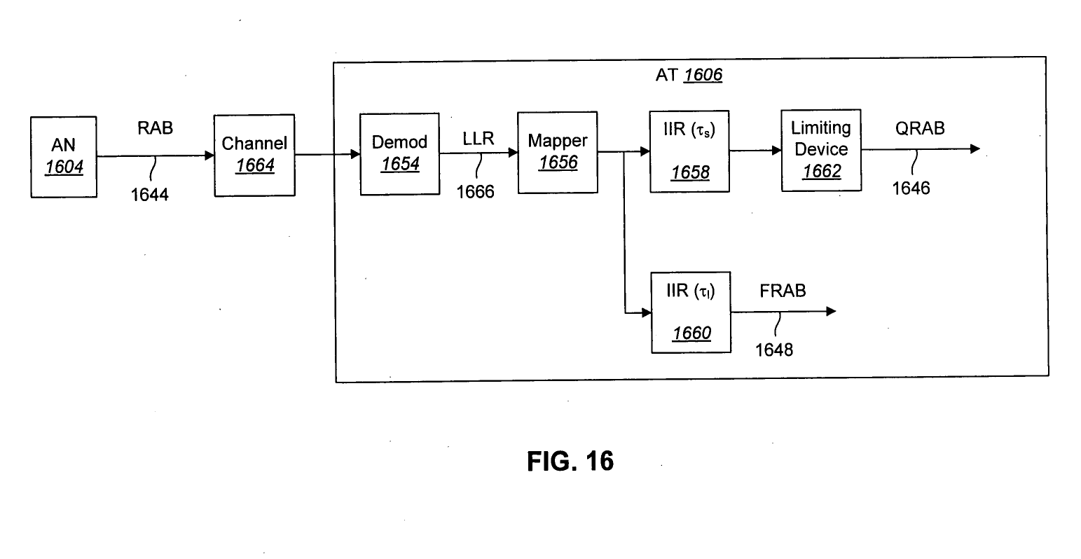

FIG. 16 is a block diagram illustrating exemplary functional components in an AT 1606 that may be used to determine QRAB 1646 and FRAB 1648. As shown, the AT 1606 may include an RAB demodulation component 1654, a mapper 1656, first and second single-pole IIR filters 1658, 1660, and a limiting device 1662.

The RAB 1644 is transmitted from the AN 1604 to the AT 1606 across a communication channel 1664. The RAB demodulation component 1654 demodulates the received signal using standard techniques that are known to those skilled in the art. The RAB demodulation component 1654 outputs a log likelihood ratio (LLR) 1666. The mapper 1656 takes the LLR 1666 as input and maps the LLR 1666 to a value between the possible values of the RAB 1644 (e.g., +1 and −1), which is an estimate of the transmitted RAB for that slot.

The output of the mapper 1656 is provided to the first single-pole IIR filter 1658. The first IIR filter 1658 has a time constant τₛ. The output of the first IIR filter 1658 is provided to a limiting device 1662. The limiting device 1662 converts the output of the first IIR filter 1658 to one of two possible values, corresponding to the two possible values of the RAB 1644. For example, if the RAB 1644 was either a −1 or a +1, then the limiting device 1662 converts the output of the first IIR filter 1658 to either a −1 or a +1. The output of the limiting device 1662 is QRAB 1646. The time constant τₛ is chosen so that QRAB 1646 represents an estimate of what the current value of the RAB 1644 transmitted from the AN 1604 is. An exemplary value for the time constant τₛ is four time slots. The QRAB reliability is improved by the filtering of IIR filter 1658. In one embodiment, the QRAB is updated once every slot.

The output of the mapper 1656 is also provided to a second single-pole IIR filter 1660 having a time constant τₗ. The output of the second IIR filter 1660 is FRAB 1648. The time constant τₗ is much longer than the time constant τₛ. An exemplary value for the time constant τₗ is 384 time slots.

The output of the second IIR filter 1660 is not provided to a limiting device. Consequently, as described above, FRAB 1648 is a real number that lies somewhere between a first value of the RAB 1644 which indicates that the sector 1432 is busy and a second value of the RAB 1644 which indicates that the sector 1432 is idle.

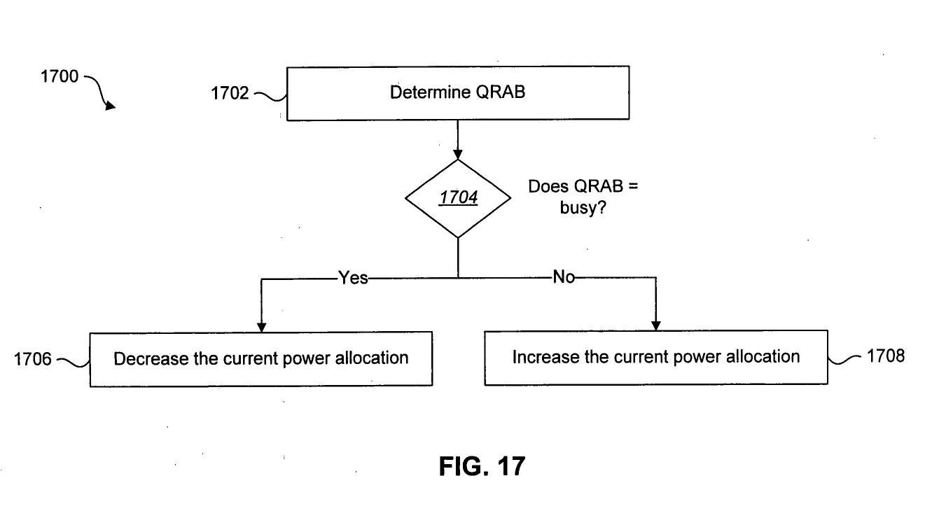

FIG. 17 illustrates an exemplary method 1700 for determining the current power allocation 1238a for a flow 1216 on the AT 1206. Step 1702 of the method 1700 involves determining the value of QRAB 1546 that is associated with the flow 1216. In step 1704, it is determined whether QRAB 1546 is equal to a busy value (i.e., a value which indicates that the sector 1432 is presently busy). If QRAB 1546 is equal to a busy value, then in step 1706 the current power allocation 1238a is decreased, i.e., the current power allocation 1238a for the flow 1216 at time n is less than the current power allocation 1238a for the flow 1216 at time n−1. The magnitude of the decrease may be calculated using the downward ramping function 1552 that is defined for the flow 1216.

If QRAB 1546 is equal to an idle value, then in step 1708 the current power allocation 1238a is increased, i.e., the current power allocation 1238a for the flow 1216 during the current time interval is greater than the current power allocation 1238a for the flow 1216 during the most recent time interval. The magnitude of the increase may be calculated using the upward ramping function 1550 that is defined for the flow 1216.

The upward ramping function 1550 and the downward ramping function 1552 are functions of the current power allocation 1238a, and are potentially different for each flow 1516 (downloadable by the AN 1404). Thus, the upward 1550 and downward 1552 ramping functions for each flow are used to achieve QoS differentiation per flow with autonomous allocation.

Also, the value of the ramping function may vary with FRAB 1548, meaning that the dynamics of ramping may vary with loading, which allows for more rapid convergence to the fixed point, i.e., a set of T2PInflow allocations, under less loaded conditions. The convergence time may be related to ramping function magnitude. It may also provide better handling of bursty sources (high peak-to-average throughput) with well-defined restrictions on T×T2P burstiness.

Where the current power allocation 1238a is increased, the magnitude of the increase may be expressed as:
ΔT2PInflow_{i,n}=+1×T2PUpᵢ(10×log₁₀(T2PInflow_{i,n-1})+PilotStrengthᵢ(PilotStrength_{n.s}),FRABₙ) (6)

Where the current power allocation 1238a is decreased, the magnitude of the decrease may be expressed as:
ΔT2PInflow_{i,n}=−1×T2PDnᵢ(10×log₁₀(T2PInflow_{i,n-1})+PilotStrengthᵢ(PilotStrength_{n,s}),FRABₙ) (7)

T2PUpᵢ is the upward ramping function 1550 for flow i. T2PDnᵢ is the downward ramping function 1552 for flow i. As stated above, each flow has a priority or demand function, a function of T2PInflow, which is the ratio of the T2Pup and T2Pdn functions. PilotStrength_{n,s} is a measure of the serving sector pilot power versus the pilot power of the other sectors. In some embodiments, it is the ratio of serving sector FL pilot power to the pilot power of the other sectors. PilotStrengthᵢ is a function mapping pilot strength to an offset in the T2P argument of the ramping function, and is downloadable from the AN. T2P represents a traffic-to-pilot power ratio. The offset refers to a gain of the traffic channel relative to the pilot. In this way, priority of the flows at an AT may be adjusted based on the AT's location in the network, as measured by the PilotStrength_{n,s} variable.

The current power allocation 1238a may be expressed as:

$$\begin{matrix}T 2 {PInflow}_{i , n} = ( 1 - ( \frac{1}{T 2 PFilterTC} ) ) \times T 2 {PInflow}_{i , n - 1} + \\ ( \frac{1}{T 2 PFilterTC} ) \times T 2 {POutflow}_{i , n - 1} + \\ Δ T 2 {PInflow}_{i , n}\end{matrix} \qquad ( 8 )$$

As can be seen from the foregoing equations, when the saturation level 1135 is reached and the ramping is set to zero, the current power allocation 1238a decays exponentially. This allows for persistence in the value of the current power allocation 1238a for bursty traffic sources, for which the persistence time should be longer than the typical packet interarrival time.

In some embodiments, a QRAB value 1546 is estimated for each sector in the active set of the AT 1206. If QRAB is busy for any of the sectors in the AT's active set, then the current power allocation 1238a is decreased. If QRAB is idle for all of the sectors in the AT's active set, then the current power allocation 1238a is increased. In alternative embodiments, another parameter QRABps may be defined. For QRABps, the measured pilot strength is taken into consideration. (The pilot strength is a measure of the serving sector pilot power versus the pilot power of the other sectors. In some embodiments, it is the ratio of serving sector FL pilot power to the pilot power of the other sectors.) QRABps may be used in interpreting short-term sector loading depending on the AT's 1206 contribution to reverse link interference in sectors in ATs 1206 active set. QRABps is set to a busy value if QRAB is busy for a sector s that satisfies one or more of the following conditions: (1) sector s is the forward link serving sector for the access terminal; (2) the DRCLock bit from sector s is out-of-lock and PilotStrength_{n,s} of sector s is greater than a threshold value; (3) the DRCLock bit from sector s is in-lock and PilotStrength_{n,s} of sector s is greater than a threshold value. Otherwise, QRABps is set to an idle value. (The AN 1204 uses the DRCLock channel to tell the AT 1206 if the AN 1204 is successfully receiving the DRC information sent by the AT 1206. More specifically, DRCLock bits (indicating “yes” or “no”) are sent over the DRCLock channel.) In embodiments where QRABps is determined, the current power allocation 1238a may be increased when QRABps is idle, and may be decreased when QRABps is busy.

Centralized Control for Each Reverse Link Carrier

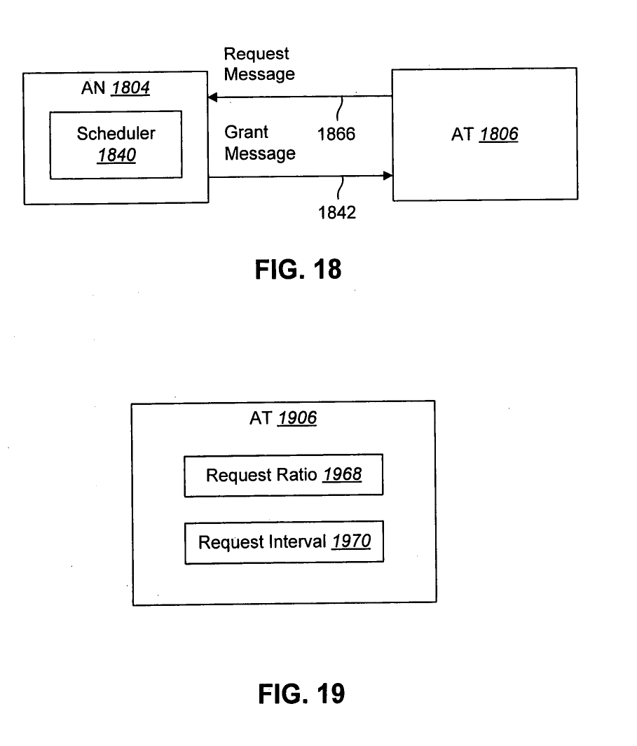

FIG. 18 illustrates an embodiment involving centralized control in which the AT 1806 sends a request message 1866 to the scheduler 1840 on the AN 1804. FIG. 18 also illustrates the scheduler 1840 sending a grant message 1842 to the AT 1806. In some embodiments, the scheduler 1840 may send grant messages 1842 to the AT 1806 on its own initiative. Alternatively, the scheduler 1840 may send grant messages 1842 to the AT 1806 in response to a request message 1866 that is sent by the AT 1806. A request message 1866 contains AT power headroom information as well as per-flow queue length information.

FIG. 19 illustrates information that may be maintained at the AT 1906 in order for the AT 1906 to determine when to send a request message 1866 to the AN 1804. As shown, the AT 1906 may be associated with a request ratio 1968. The request ratio 1968 indicates the ratio of request message size 1866 sent on the reverse traffic channel 208 to data sent on the reverse traffic channel 208. In some embodiments, when the request ratio 1968 decreases below a certain threshold value, then the AT 1906 sends a request message 1866 to the scheduler 1840.

The AT 1906 may also be associated with a request interval 1970. The request interval 1970 indicates the period of time since the last request message 1866 was sent to the scheduler 1840. In some embodiments, when the request interval 1970 increases above a certain threshold value, then the AT 1906 sends a request message 1866 to the scheduler 1840. Both methods to trigger request messages 1866 may be used together as well (i.e., a request message 1866 may be sent when either method causes it).

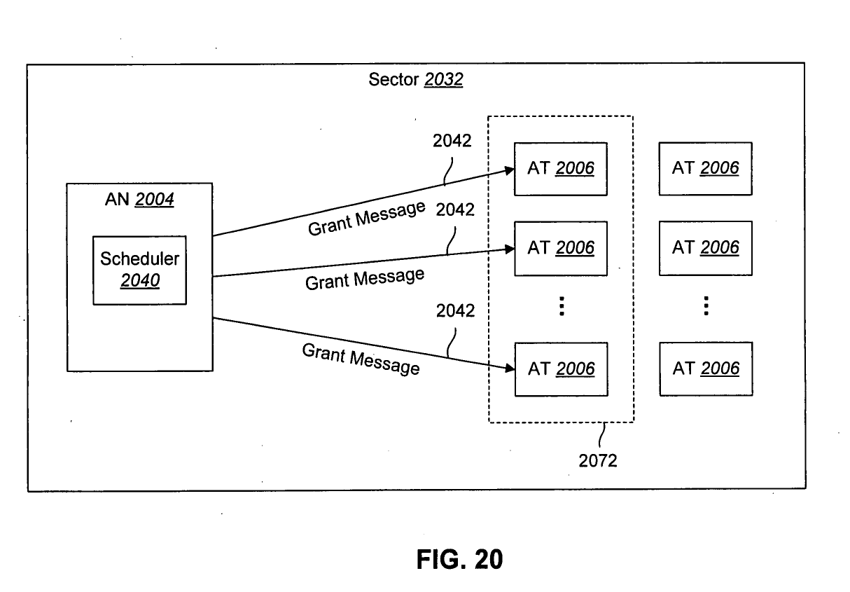

FIG. 20 illustrates an exemplary interaction between a scheduler 2040 running on the AN 2004 and the ATs 2006 within the sector 2032. As shown in FIG. 20, the scheduler 2040 may determine current power allocation grants 1374 for a subset 2072 of the ATs 2006 within the sector 2032. A separate current power allocation grant 1374 may be determined for each AT 2006. Where the ATs 2006 in the subset 2072 include more than one flow 1216, the scheduler 2040 may determine separate current power allocation grants 1374 for some or all of the flows 1216 on each AT 2006. The scheduler 2040 periodically sends grant messages 2042 to the ATs 2006 in the subset 2072. In one embodiment, the scheduler 2040 may not determine current power allocations grants 1374 for the ATs 2006 within the sector 2032 that are not part of the subset 2072. Instead, the remaining ATs 2006 in the sector 2032 autonomously determine their own current power allocations 1038a. The grant messages 2042 may include a holding period for some or all of the current power allocation grants 1374. The holding period for a current power allocation grant 1374 indicates how long the AT 2006 keeps the current power allocation 1238a for the corresponding flow 1216 at the level specified by the current power allocation grant 1374.

In accordance with the approach illustrated in FIG. 20, the scheduler 2040 may not be designed to fill all of the capacity in the sector 2032. Instead, the scheduler 2040 determines the current power allocations 1038a for the ATs 2006 within the subset 2072, and then the remaining sector 2032 capacity is used efficiently by the remaining ATs 2006 without intervention from the scheduler 2040. The subset 2072 may change over time, and may even change with each grant message 2042. Also, the decision to send a grant message 2042 to some subset 2072 of ATs 2006 may be triggered by any number of external events, including detection that some flows 1216 are not meeting certain QoS requirements.

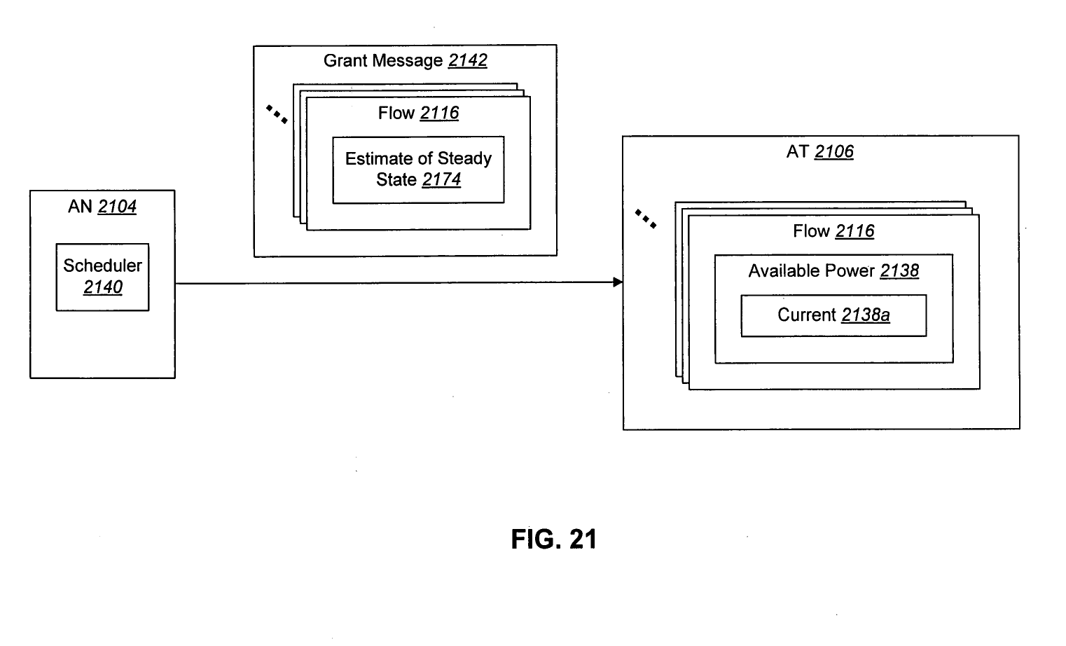

FIG. 21 illustrates another exemplary interaction between a scheduler 2140 running on the AN 2104 and an AT 2106. In some embodiments, if the AT 2106 is allowed to determine the current power allocations 2138a for the flows 2116 on the AT 2106, each of the current power allocations 2138a will, over time, converge to a steady-state value. For example, if one AT 2106 enters an unloaded sector 2132 with a flow 2116 that has data to transmit, the current power allocation 2138a for that flow 2116 will ramp up until that flow 2116 takes up the entire sector 2132 throughput. However, it may take some time for this to occur.

An alternative approach is for the scheduler 2140 to determine estimates of the steady-state values that the flows in each AT 2106 will ultimately reach. The scheduler 2140 may then send a grant message 2142 to all ATs 2106. In the grant message 2142, the current power allocation grant 2174 for a flow 2116 is set equal to the estimate of the steady-state value for that flow 2116, as determined by the scheduler 2140. Upon receiving the grant message 2142, the AT 2106 sets the current power allocations 2138a for the flows 2116 on the AT 2106 equal to the steady-state estimates 2174 in the grant message 2142. Once this is done, the AT 2106 may subsequently be allowed to track any changes in system conditions and autonomously determine the current power allocations 2138a for the flows 2116, without further intervention from the scheduler 2140.

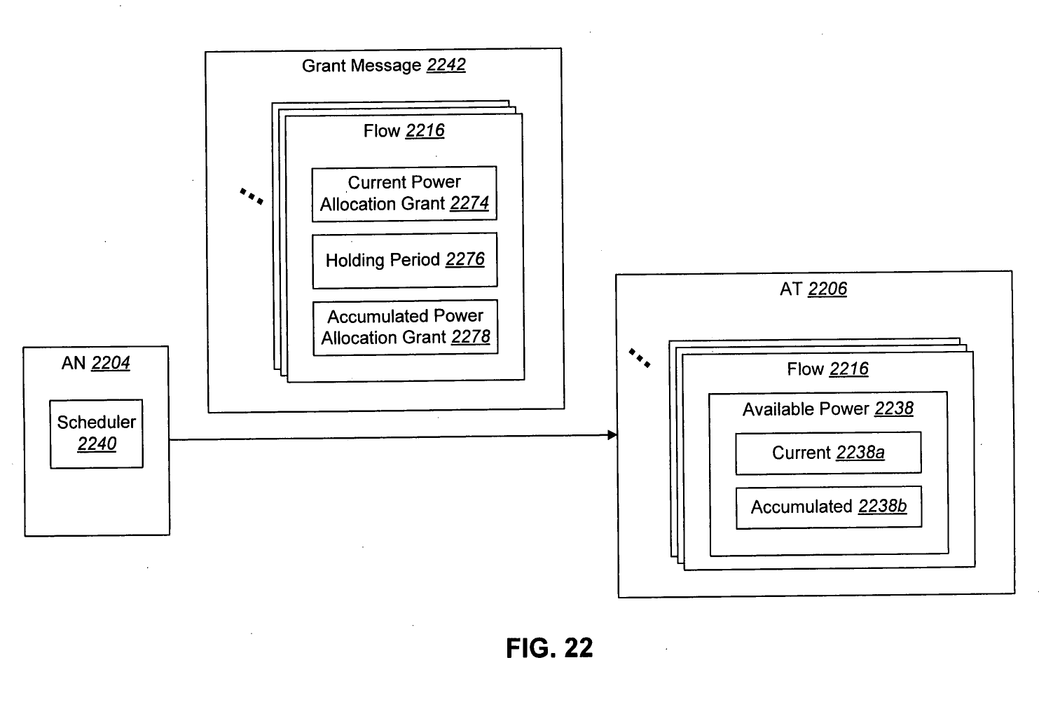

FIG. 22 illustrates another embodiment of a grant message 2242 that is transmitted from the scheduler 2240 on the AN 2204 to the AT 2206. As before, the grant message 2242 includes a current power allocation grant 2274 for one or more of the flows 2216 on the AT 2206. In addition, the grant message includes a holding period 2276 for some or all of the current power allocation grants 2274.

The grant message 2242 also includes an accumulated power allocation grant 2278 for some or all of the flows 2216 on the AT 2206. Upon receiving the grant message 2242, the AT 2206 sets the accumulated power allocations 2238b for the flows 2216 on the AT 2206 equal to the accumulated power allocation grants 2278 for the corresponding flows 2216 in the grant message 2242.

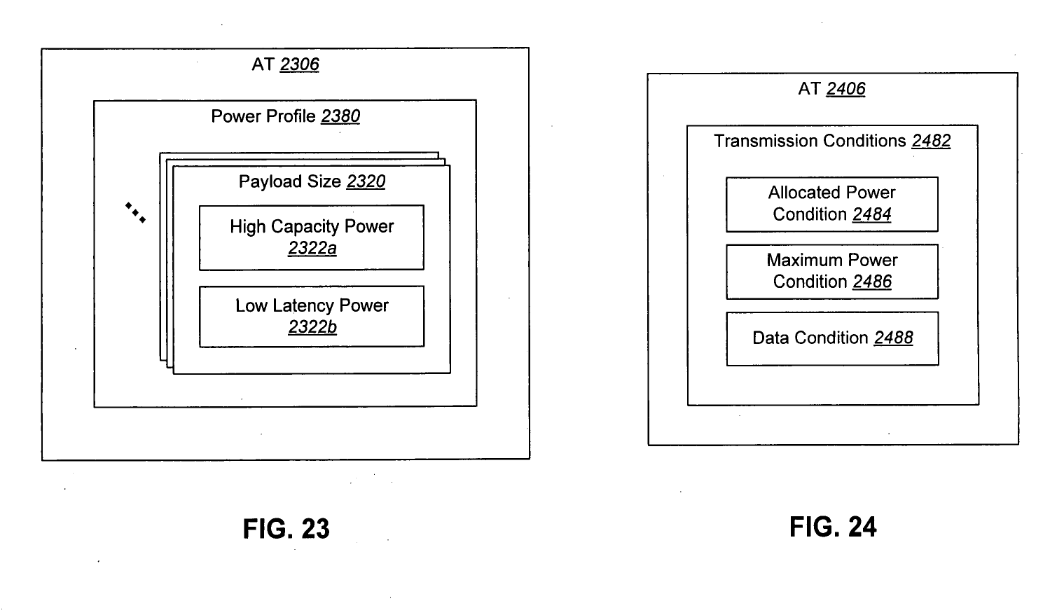

FIG. 23 illustrates a power profile 2380 that may be stored at the AT 2306, in some embodiments. The power profile 2332 may be used to determine the payload size 420 and the power level 422 of a packet that is transmitted by the AT 2306 to the AN 204.

The power profile 2380 includes a plurality of payload sizes 2320. The payload sizes 2320 included in the power profile 2380 are the possible payload sizes 2320 for the packets 524 that are transmitted by the AT 2306.

Each payload size 2320 in the power profile 2380 is associated with a power level 2322 for each possible transmission mode. In the illustrated embodiment, each payload size 2320 is associated with a high capacity power level 2322a and a low latency power level 2322b. The high capacity power level 2322a is the power level for a high capacity packet 524a with the corresponding payload size 2320. The low latency power level 2322b is the power level for a low latency packet 524b with the corresponding payload size 2320.

FIG. 24 illustrates a plurality of transmission conditions 2482 that may be stored at the AT 2406. In some embodiments, the transmission conditions 2482 influence the selection of the payload size 420 and the power level 422 for a packet 524.

The transmission conditions 2482 include an allocated power condition 2484. The allocated power condition 2484 relates generally to ensuring that the AT 2406 is not using more power than it has been allocated. More specifically, the allocated power condition 2484 is that the power level 422 of the packet 524 does not exceed the total available power 1034 for the AT 2406. Various exemplary methods for determining the total available power 1034 for the AT 2406 were discussed above.

The transmission conditions 2482 also include a maximum power condition 2486. The maximum power condition 2486 is that the power level 422 of the packet 524 does not exceed a maximum power level that has been specified for the AT 2406.

The transmission conditions 2482 also include a data condition 2488. The data condition 2488 relates generally to ensuring that the payload size 420 of the packet 524 is not too large in view of the total available power 1034 of the AT 2406 as well as the amount of data that the AT 2406 presently has available for transmission. More specifically, the data condition 2488 is that there is not a payload size 2320 in the power profile 2380 that corresponds to a lower power level 2322 for the transmission mode of the packet 524 and that is capable of carrying the lesser of (1) the amount of data that is presently available for transmission, and (2) the amount of data that the total available power 1034 for the AT 2406 corresponds to.

The following provides a mathematical description of the transmission conditions 2482. The allocated power condition 2484 may be expressed as:
T×T2PNominal_{PS,TM}≦Σ_{iεF}(PotentialT2POutflow_{i,TM}) (9)

T×T2PNominal_{PS,TM} is the power level 2322 for payload size PS and transmission mode TM. F is the flow set 418.

The maximum power condition 2486 may be expressed as:
max(T×T2PPreTransition_{PS,TM},T×T2PPostTransition_{PS,TM})≦T×T2Pmax (10)

In some embodiments, the power level 422 of a packet 524 is permitted to transition from a first value to a second value at some point during the transmission of the packet 524. In such embodiments, the power level 2322 that is specified in the power profile 2380 includes a pre-transition value and a post-transition value. T×T2PPreTransition_{PS,TM} is the pre-transition value for payload size PS and transmission mode TM. T×T2PPostTransition_{PS,TM} is the post-transition value for payload size PS and transmission mode TM. T×T2Pmax is a maximum power level that is defined for the AT 206, and may be a function of the PilotStrength measured by the AT 206. PilotStrength is a measure of the serving sector pilot power versus the pilot power of the other sectors. In some embodiments, it is the ratio of serving sector FL pilot power to the pilot power of the other sectors. It may also be used to control the up and down ramping that the AT 206 performs autonomously. It may also be used to control T×T2Pmax, so that ATs 206 in poor geometries (e.g. at the edge of sectors) may restrict their maximum transmit power, to avoid creating unwanted interference in other sectors. In one embodiment, this may be achieved by adjusting the gu/gd ramping based on the forward link pilot strength.

In some embodiments, the data condition 2488 is that there is not a payload size 2320 in the power profile 2380 that corresponds to a lower power level 2322 for the transmission mode of the packet 524 and that is capable of carrying a payload of size given by:
Σ_{iεF}min(d_{i,n},T2PConversionFactor_{TM}×PotentialT2POutflow_{i,TM}) (11)

In equation 11, d_{i,n} is the amount of data from flow i (2616) that is included in the sub-packet that is transmitted during sub-frame n. The expression T2PConversionFactor_{TM}×PotentialT2POutflow_{i,TM} is the transmittable data for flow i, i.e., the amount of data that the total available power 1034 for the AT 2406 corresponds to. T2PConversionFactor_{TM} is a conversion factor for converting the total available power 1238 for flow i (2616) into a data level.

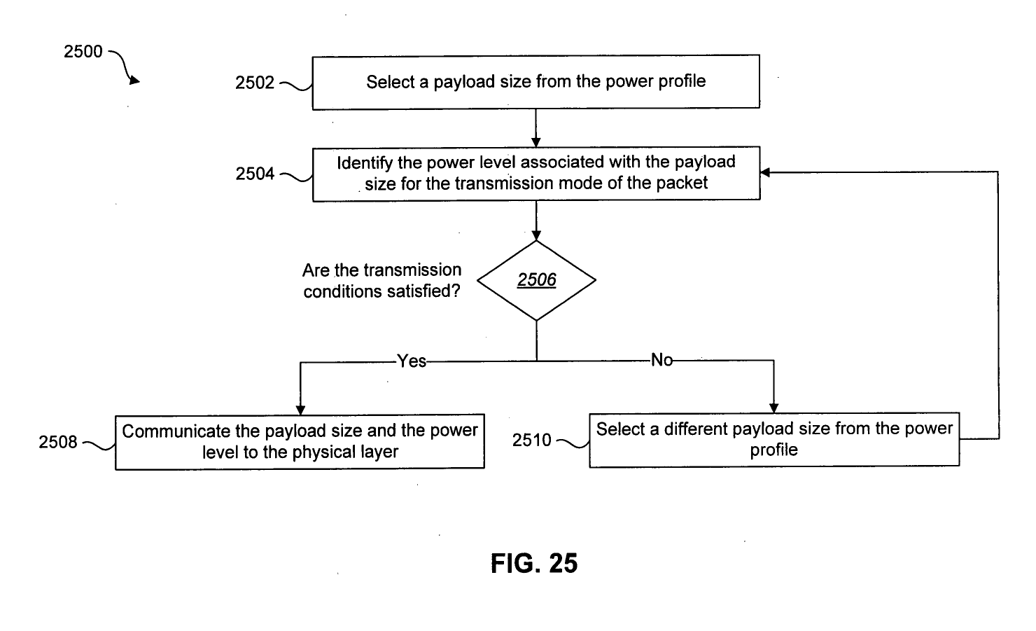

FIG. 25 illustrates an exemplary method 2500 that the AT 206 may perform in order to determine the payload size 420 and the power level 422 for a packet 524. Step 2502 involves selecting a payload size 2320 from the power profile 2380. Step 2504 involves identifying the power level 2322 associated with the selected payload size 2320 for the transmission mode of the packet 524. For example, if the packet 524 is going to be transmitted in high capacity mode, then step 2504 involves identifying the high capacity power level 2322a associated with the selected payload size 2320. Conversely, if the packet is going to be transmitted in low latency mode, then step 2504 involves identifying the low latency power level 2322b associated with the selected payload size 2320.

Step 2506 involves determining whether the transmission conditions 2482 are satisfied if the packet 524 is transmitted with the selected payload size 2320 and the corresponding power level 2322. If in step 2506 it is determined that the transmission conditions 2482 are satisfied, then in step 2508 the selected payload size 2320 and the corresponding power level 2322 are communicated to the physical layer 312.

If in step 2506 it is determined that the transmission conditions 2482 are not satisfied, then in step 2510 a different payload size 2320 is selected from the power profile 2380. The method 2500 then returns to step 2504 and proceeds as described above.

The design philosophy behind multiflow allocation is that the total power available is equal to the sum of the power available for each flow in the access terminal 2606. This method works well up to the point that the access terminal 2606 itself runs out of transmit power, either due to hardware limits (PA headroom limited), or due to T×T2Pmax limits. When transmit power is limited, further arbitration of flow power allocation in the access terminal 2606 is necessary. As discussed above, when there are no power limits, the gu/gd demand function determines each flow's current power allocation through normal function of the RAB and flow ramping.

On the other hand, when AT 2606 power is limited, one method to set flow 2616 allocation is to consider the AT 2606 power limit as strictly analogous to the sector power limit. Generally the sector has a max receive power criterion that is used to set the RAB, which then leads to each flow's power allocation. The idea is that when the AT 2606 is power limited, each flow in that AT 2606 is set to the power allocation that it would receive if the AT's 2606 power limit were actually the corresponding limit of the sector's received power. This flow power allocation may be determined directly from the gu/gd demand functions, either by running a virtual RAB inside the AT 2606, or by other equivalent algorithms. In this way, intra-AT 2606 flow priority is maintained and is consistent with inter-AT 2606 flow priority. Further, no information beyond the existing gu and gd functions is necessary.

A summary of various features of some or all of the embodiments described herein will now be provided. The system allows for a decoupling of the mean resource allocation (T2PInflow 2635) and how this resource is used for packet allocation (including control of peak rate and peak burst duration).

Packet 524 allocation may remain autonomous in all cases. For mean resource allocation, either scheduled or autonomous allocation is possible. This allows seamless integration of scheduled and autonomous allocation, as the packet 524 allocation process behaves the same in both cases, and mean resource may be updated as often or not as desired.

Control of hold time in the grant message allows precise control of resource allocation timing with minimal signaling overhead.

BucketLevel control in the grant message allows for a quick injection of resource to a flow without affecting its mean allocation over time. This is a kind of ‘one-time use’ resource injection.

The scheduler 2640 may make an estimate of the ‘fixed-point’, or the proper resource allocation for each flow 2616, and then download these values to each flow 2616. This reduces the time for the network to get close to its proper allocation (a ‘coarse’ allocation), and then the autonomous mode rapidly achieves the ultimate allocation (the ‘fine’ allocation).

The scheduler 2640 may send grants to a subset of the flows 2616, and allow the others to run autonomous allocation. In this way, resource guarantees may be made to certain key flows, and then the remaining flows then autonomously ‘fill-in’ the remaining capacity as appropriate.

The scheduler 2640 may implement a ‘shepherding’ function where transmission of a grant message only occurs when a flow is not meeting QoS requirements. Otherwise, the flow is allowed to autonomously set its own power allocation. In this way, QoS guarantees may be made with minimal signaling and overhead. Note that in order to achieve a QoS target for a flow, the shepherding scheduler 2640 may grant a power allocation different from the fixed-point solution of the autonomous allocations.

The AN 2604 may specify per-flow design of the ramping functions, up and down. Appropriate choice of these ramping functions allows precise specifying of any per-flow 2616 mean resource allocation with purely autonomous operation only, using 1-bit of control information in each sector.

The Very rapid timing implied in the QRAB design (updated every slot and filtered with a short time constant at each AT 2606) allows for very tight control of each flow's power allocation, and maximizes overall sector capacity while maintaining stability and coverage.

Per-flow 2616 control of the peak power is allowed as a function of the mean power allocation and the sector loading (FRAB). This allows for trading off timeliness of bursty traffic with the effect on overall sector 1432 loading and stability.

Per-flow 2616 control of the max duration of transmission at the peak power rate is allowed, through the use of BurstDurationFactor. In conjunction with the peak rate control, this allows for control of sector 1432 stability and peak loading without central coordination of autonomous flow allocation, and allows for tuning requirements to specific source types.

Allocation to bursty sources is handled by the bucket mechanism and persistence of T2PInflow 2635, which allows for mapping of the mean power allocation to bursty source arrivals while maintaining control of the mean power. The T2PInflow 2635 filter time constant controls the persistence time over which sporadic packet 524 arrivals are allowed, and beyond which T2PInflow 2635 decays to a minimal allocation.

The dependence of T2PInflow 2635 ramping on FRAB 1548 allows for higher ramping dynamics in less loaded sectors 1432, without affecting the final mean power allocation. In this way aggressive ramping may be implemented when a sector is less loaded, while good stability is maintained at high load levels by reducing ramping aggressiveness.

T2PInflow 2635 is self-tuning to the proper allocation for a given flow 2616 via autonomous operation, based on flow priority, data requirements, and available power. When a flow 2616 is over-allocated, the BucketLevel reaches the BucketLevelSat value or level 2635, the up-ramping stops, and the T2PInflow 2635 value will decay down to the level at which BucketLevel is less than BucketLevelSat 2635. This is then the appropriate allocation for T2PInflow 2635.

Besides the per-flow QoS differentiation available in autonomous allocation based on up/down ramping function design, it is also possible to control flow 2216 power allocation based on channel conditions, via QRAB or QRABps and the dependency of ramping on PilotStrength. In this way flows 2616 in poor channel conditions may get lower allocation, reducing interference and improving the overall capacity of the system, or may get full allocation independent of channel condition, which maintains uniform behavior at the expense of system capacity. This allows control of the fairness/general welfare tradeoff.

As far as possible, both inter-AT 2606 and intra-AT 2606 power allocation for each flow 2216 is as location-independent as possible. This means that it doesn't matter what other flows 2616 are at the same AT 2606 or other AT's 2606, a flow's 2216 allocation only depends on the total sector loading. Some physical facts limit how well this goal may be attained, particularly the max AT 2606 transmit power, and issues about merging high capacity (HiCap) and low latency (LoLat) flows 2616.

In keeping with this approach, the total power available for an AT 2606 packet allocation is the sum of the power available to each flow in the AT 2606, subject to the AT's 2606 transmit power limitation.

Whatever rule is used to determine data allocation from each flow 2216 included in a packet allocation, precise accounting of the flow's 2216 resource usage is maintained in terms of bucket withdrawal. In this way, inter-flow 2216 fairness is guaranteed for any data-allocation rule.

When the AT 2606 is power limited and can't accommodate the aggregate power available to all its flows 2616, power is used from each flow appropriate to the lesser power available within the AT 2606. That is, the flows within the AT 2606 maintain the proper priority relative to each other, as though they were sharing a sector with just those AT's 2606 and that max power level (the AT 2606 power limit is analogous to the power limit of the sector as a whole). The power remaining in the sector not used up by the power-limited AT-2606 is then available for the other flows 2616 in the sector as usual.

High capacity flows 2216 may be merged into low latency transmissions when the sum of high capacity potential data usage in one AT 2606 is high enough that not merging would lead to a large power differential across packets 524. This maintains smoothness in transmitted power appropriate to a self-interfering system. High capacity flows 2216a may be merged into low latency transmissions when a specific high capacity flow 2216a has delay requirements such that it can't wait for all low latency flows 2216b in the same AT 2606 to transmit, then upon reaching a threshold of potential data usage, the flow may merge its data into low latency transmissions. Thus, delay requirements for high capacity flows 2216a may be met when sharing an AT 2606 with persistent low latency flows 2216b. High capacity flows may be merged into low latency transmissions when a sector is lightly loaded, the efficiency loss in sending high capacity flows 2216a as low latency is not important, and hence merging may always be allowed.

A set of high capacity flows 2216a may be transmitted in low latency mode even if there are no active low latency flows 2216b, when the packet size for high capacity mode would be at least PayloadThresh in size. This allows for high capacity mode flows to achieve the highest throughput when their power allocation is high enough, as the highest throughput for an AT 2606 occurs at the largest packet 524 size and low latency transmission mode. To say it another way, the peak rate for high capacity transmission is much lower than that of low latency transmission, so a high capacity mode flow 2216a is allowed to use low latency transmission when it is appropriate that it achieves the highest throughput.

Each flow 216 has a T2Pmax parameter which restricts its maximum power allocation. It may also be desirable to restrict an AT's 2606 aggregate transmit power, perhaps dependent on its location in the network (e.g. when at the boundary of two sectors an AT 2606 creates added interference and affects stability). The parameter T×T2Pmax may be designed to be a function of PilotStrength, and limits the AT's 2606 maximum transmit power.

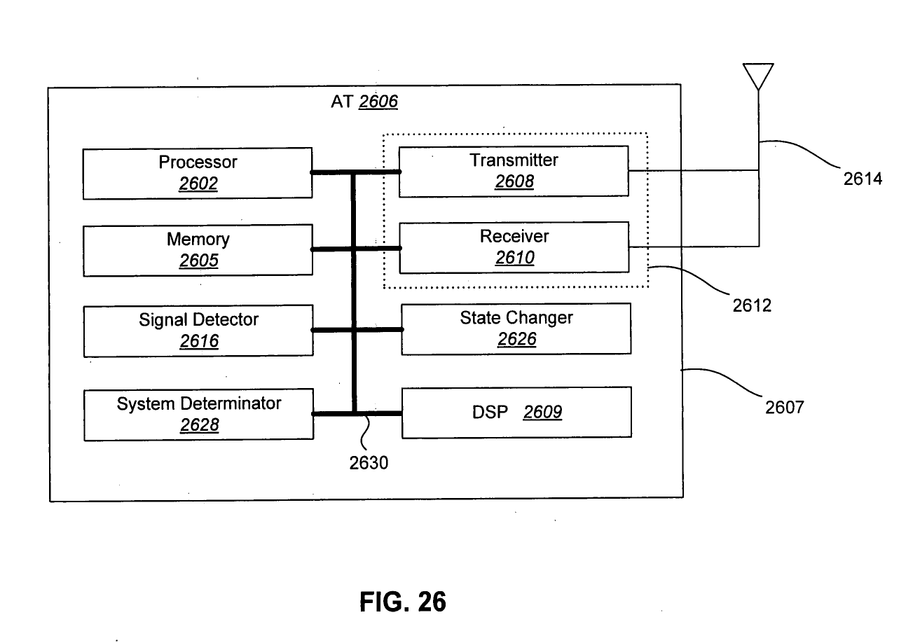

FIG. 26 is a functional block diagram illustrating an embodiment of an AT 2606. The AT 2606 includes a processor 2602 which controls operation of the AT 2606. The processor 2602 may also be referred to as a CPU. Memory 2605, which may include both read-only memory (ROM) and random access memory (RAM), provides instructions and data to the processor 2602. A portion of the memory 2605 may also include non-volatile random access memory (NVRAM).

The AT 2606, which may be embodied in a wireless communication device such as a cellular telephone, may also include a housing 2607 that contains a transmitter 2608 and a receiver 2610 to allow transmission and reception of data, such as audio communications, between the AT 2606 and a remote location, such as an AN 2604. The transmitter 2608 and receiver 2610 may be combined into a transceiver 2612. An antenna 2614 is attached to the housing 2607 and electrically coupled to the transceiver 2612. Additional antennas (not shown) may also be used. The operation of the transmitter 2608, receiver 2610 and antenna 2614 is well known in the art and need not be described herein.

The AT 2606 also includes a signal detector 2616 used to detect and quantify the level of signals received by the transceiver 2612. The signal detector 2616 detects such signals as total energy, pilot energy per pseudonoise (PN) chips, power spectral density, and other signals, as is known in the art.

A state changer 2626 of the AT 2606 controls the state of the wireless communication device based on a current state and additional signals received by the transceiver 2612 and detected by the signal detector 2616. The wireless communication device is capable of operating in any one of a number of states.

The AT 2606 also includes a system determinator 2628 used to control the wireless communication device and determine which service provider system the wireless communication device should transfer to when it determines the current service provider system is inadequate.

The various components of the AT 2606 are coupled together by a bus system 2630 which may include a power bus, a control signal bus, and a status signal bus in addition to a data bus. However, for the sake of clarity, the various busses are illustrated in FIG. 26 as the bus system 2630. The AT 2606 may also include a digital signal processor (DSP) 2609 for use in processing signals. One skilled in the art will appreciate that the AT 2606 illustrated in FIG. 6 is a functional block diagram rather than a listing of specific components.

Multi-Carrier, Multi-Flow, Reverse Link Medium Access Control

Up to this point, the previous embodiments discussed related to single carrier systems where a RLMAC bucket was used for each flow 2616 to police as well as control access in the T2P domain. The devices and processes described herein may also be implemented in a multi-carrier, multi-flow, reverse link system, where each access terminal may transmit pilot, overhead and traffic signals, separately or together, on multiple carriers, i.e., frequency bands. For example, if a carrier has a frequency band of 1.25 MHz (megahertz), a 5 MHz frequency band may include 3 or 4 carriers.

In one multi-carrier embodiment, an AT 2606 has multiple application flows 2216 running concurrently. These application flows map to MAC (Medium Access Control) layer flows in the AT 2606, where, under centralized control, the mapping is controlled by an AN 2604. AT 2606 has a maximum total amount of power available for transmission across all the assigned carriers. The MAC at the AT 2606 determines the amount of power to be allocated for transmission to each flow 2616 on each assigned carrier, such that various constraints are satisfied such as the Quality of Service (QoS) constraints of the flow 2216 (e.g., delay, jitter, error rate etc.), and the loading constraints of the network (e.g., Rise Over Thermal, or load in each sector).

The MAC is designed such that the AN 2604 determines a centralized set of parameters, some of which are flow-dependent while others are carrier-dependent, while the AT 2606 determines the per-physical-layer-packet power allocation for each flow 2216 in each carrier. Depending on various design goals, the AN 2604 can choose to control the flow 2216 allocations, for flows residing in the same AT 2606 as well as for flows 2216 residing in different ATs 2606, across different carriers in the network by determining an appropriate set of centralized parameters.

Policing Data Flow in a Multi-Carrier System

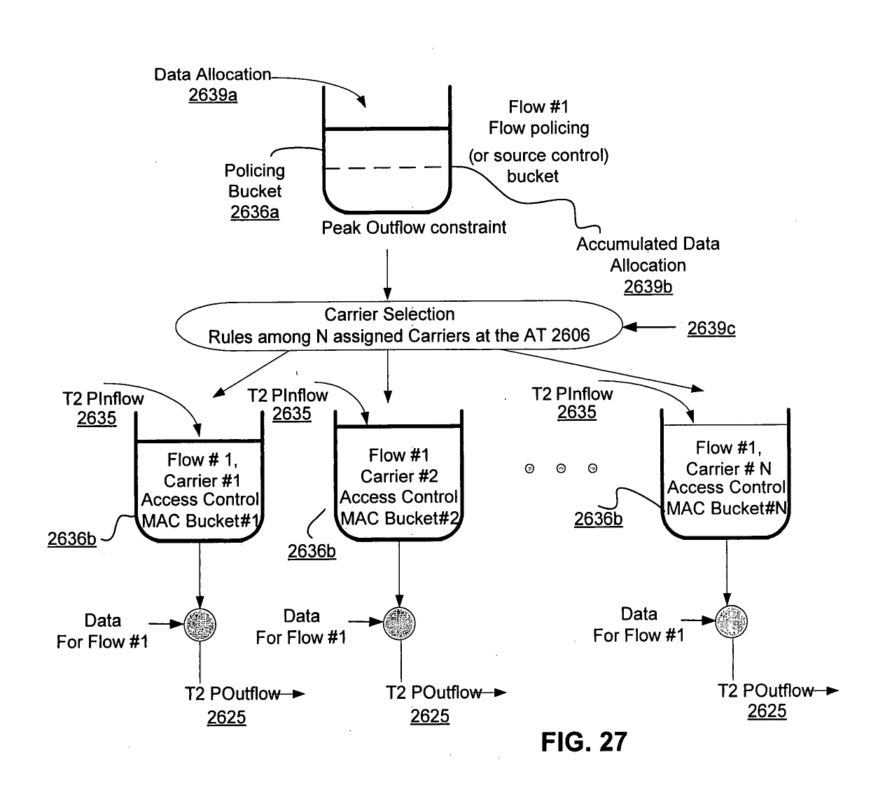

When an AT 2606 is assigned multiple RL carriers, the data flow 2216 access control in each RL carrier assigned to the AT 2606 is decoupled from flow 2216 data policing at the AT 2606 by using two separate sets of token buckets for each MAC layer flow 2216. See FIG. 27. (This differs from the single carrier embodiment in which flow 2216 access control and flow 2216 data policing are coupled by a single bucket mechanism). The data generated by an application flow 2216 is first regulated by a policing token bucket 2636a defined in the data domain (for policing of the data flow 2216). In one embodiment, there is a single policing function per flow 2216. The policing function ensures that average and peak resources utilized by a flow 2216 is less than or equal to a limit. In one embodiment, the flow 2216 (or AT 2606) may not abuse the additional allocation in a multi-carrier system and the policing is performed in the data domain.

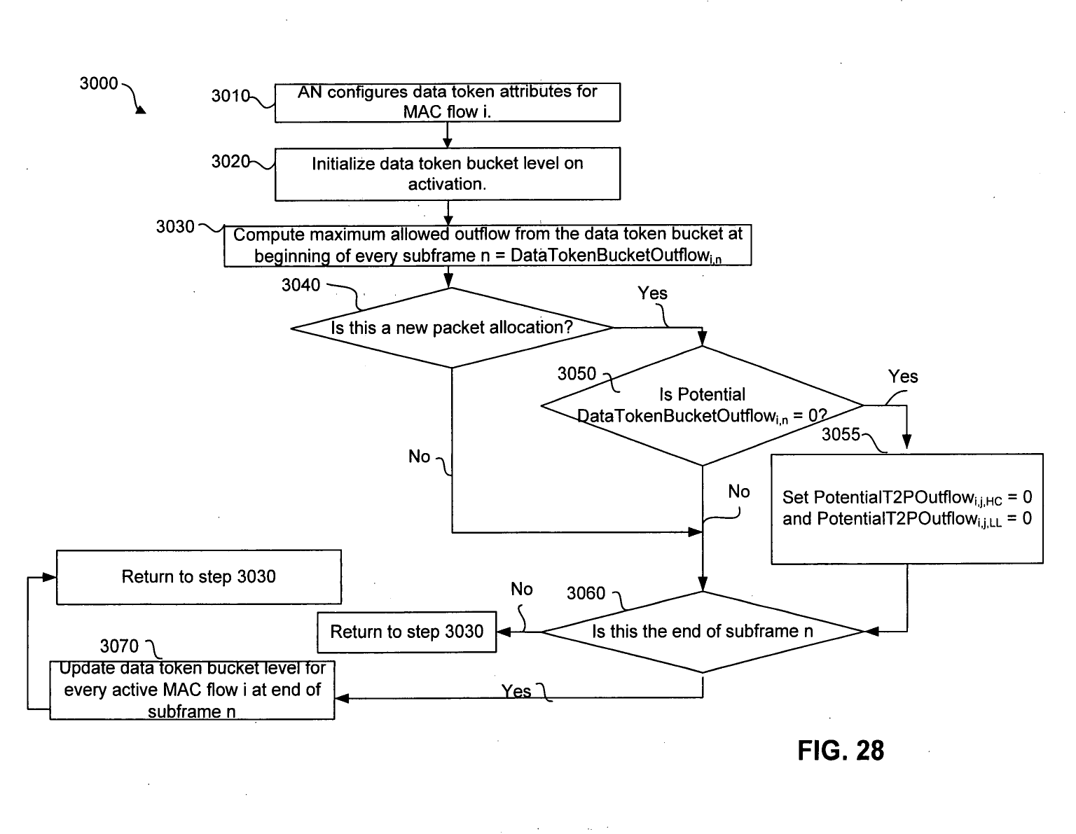

The following steps shown in FIG. 28 are executed when policing flow 2216 data in the RTC MAC layer. To begin with, the AN 2604 configures the following data token bucket attributes (step 3010):

DataBucketLevelMaxᵢ=Data token bucket 2636a maximum size for MAC flow i (2216) (in Octets).

DataTokenInflowᵢ=Data token inflow into the policing bucket 2636a per subframe (in Octets) for MAC flow i (2216).

DataTokenOutflowᵢ=Data token outflow out of the policing bucket 2636a per subframe (in Octets) for MAC flow i (2216).

Next, the data token bucket (or policing bucket 2636a) level, DataTokenBucketlevelᵢ, is initialized on activation for MAC flow i (2216) by setting it to a maximum bucket level, DataBucketLevelMaxᵢ, (step 3020), which may expressed as:
DataTokenBucketlevelᵢ=DataBucketLevelMaxᵢ (12)

Next, at the beginning of every subframe n, compute a maximum allowed outflow from the data token bucket (or policing bucket) 2636a for every active MAC flow i (2216) and set the total available power for the policing bucket 2636a equal to either to this maximum value or zero if this maximum value is negative (step 3030). The total available power for the data outflow of the policing bucket 2636a may be expressed as:
PotentialDataTokenBucketOutflow_{i,n}=max(DataTokenInflowᵢ+DataTokenBucketLevel_{i,n}, 0) (13),

where i represents the MAC flow 2216, n represents the subframe, DataTokenlnflowᵢ represents the is the current data allocation 2639a for flow i (2216) and DataTokenBucketLevel_{i,n} is the accumulated data allocation 2639b for data flow i (2216) at subframe n.

Next, determine if this a new packet allocation (step 3040). If the answer to step 3040 is no, then go to step 3060. If the answer to step 3040 is yes, then execute the following step 3050 during new packet allocation in every assigned carrier j at subframe n. If the total available data of the policing bucket 2639a for flow i (2216), subframe n, PotentialDataTokenBucketOutflow_{i,n}, equals zero (step 3050), which may be expressed as:
PotentialDataTokenBucketOutflow_{i,n}=0 (14),

then set the total available power 1238 for the ith flow on the jth carrier for high capacity packets 524a, PotentialT2POutflow_{i,j,HC} equal to zero and the total available power 1238 for the ith flow (2216) on the jth carrier for low latency packets 524a, PotentialT2POutflow_{i,j,LL} equal to zero (step 3055). These equalities may be expressed as:
PotentialT2POutflow_{i,j,HC}=0 (15)
PotentialT2POutflow_{i,j,LL}=0 (16),

where i represents the MAC flow 2216, j represents the jth carrier, n represents the subframe, HC represents High Capacity and LL represents Low Latency.

If the answer to step 3050 is no, then go to step 3060. This ensures that the power allocated to a flow in every assigned RL carrier at the AT is set to sero when the flow exceeds the data bucket allocation.

Next, it is determined if this is the end of a subframe n (step 3060). If the answer to step 3060 is no, then return to step 3030. If the answer to step 3060 is yes, then at the end of every subframe n, update the data token bucket level for every active MAC flow i (2216) by setting the data token bucket level for frame n+1 equal to the minimum of the current data allocation 2639a for flow i (2216), DataTokenInflowᵢ, plus the accumulated data allocation 2639b for data flow i (2216) at subframe n (2216), DataTokenBucketLevel_{i,n}, minus the number of octets from MAC flow i (2216) contained in the payload in all carriers j at subframe n, Σ_{jεC}d_{i,j,n,} or the data token bucket 2636a maximum size for flow i (2216), DataBucketLevelMaxᵢ (step 3070). This may be expressed as:
DataTokenBucketLevel_{i,n+1}=min(DataTokenInflowᵢ+DataTokenBucketLevel_{i,n}−Σ_{jεC}d_{i,j,n}, DataBucketLevelMaxᵢ) (17)

where d_{j,i,n}=number of octets from MAC flow i (2216) contained in the payload in carrier j at subframe n, C=set of all carriers assigned to the AT 2606, Σ_{jεC}d_{i,j,n} is the number of octets from MAC flow i (2216) contained in the payload in all carriers j at subframe n, DataTokenInflowᵢ is the current data allocation 2639a for flow i (2216), DataTokenBucketLevel_{i,n} is the accumulated data allocation 2639b for data flow i (2216) at subframe n, and DataBucketLevelMaxᵢ is the data token bucket 2636a maximum size for flow i (2216). Return to step 3030.

The output of this data-domain token bucket 2636a is then regulated by a second set of token buckets 2636b which is defined in the T2P or power domain. These second buckets, or flow access buckets 2636b, determine the potential allowed transmission power for each MAC flow 2216 in each assigned carrier. Thus, each of the second buckets 2636b represents an assigned carrier and the flow 2216 located on the carrier. Thus, under multi-carrier, flow 2216 access is controlled on a per carrier basis in which the number of assigned RLMAC buckets may be set equal to the number of carriers assigned to each flow 2216.

FIG. 27 illustrates an example of decoupling flow policing from access control in which data is first placed into a flow policing (or source control) bucket 2636a for that flow 2616, and then, subject to a peak, outflow constraint, allocated to the different carriers using a set of carrier selection rules 2639c that, in one embodiment, may be stored in memory as instructions which may be executed by a processor or processor means. Each of the N carriers has its own access control bucket 2636b labeled 1 through N which correspond to the 1 through N carriers. Thus, the number of buckets 2636b may be set equal to the number of assigned carriers for each flow 2216.

The final power allocation for each flow 2216 in each carrier is then determined by using the output of the second T2P domain based token bucket 2636b, and a set of rules as defined below.

Carrier Selection Policy at the AT 2606

The AT 2606 ranks all assigned carriers based on a metric. In one embodiment, the average transmit power of the pilot signal of the AT 2606 (TxPilotPower) may be used as a carrier ranking metric. If the carrier with the lowest average TxPilotPower is unavailable for a new packet allocation at a given subframe, then use other lower ranked carriers. The filter time constant for averaging TxPilotPower has the following effect—the AT 2606 can gain from exploiting short term fading variations by using a small filter time constant. On the other hand, a longer time constant reflects long time variations in total interference seen by the AT 2606 in each assigned RL carrier. Note that average FRAB 1548 or a function of average TxPilotPower and average FRAB 1548 are also possible metrics. The AT 2606 allocates packets on each carrier based on their ranking until the AT 2606 runs out of data, PA headroom, or carriers. The multi-carrier RTC MAC of the present method and apparatus may iterate (add or drop) over assigned carriers based on their ranking until the AT 2606 is out of data or out of PA headroom.

A signal-to-noise ratio can also be used as a metric. The AT 2606 achieves load balancing by favoring carriers with lower interference. The AT 2606 transmits over a subset of assigned carriers in order to operate in a more E_{b}/N₀ efficient mode to minimize the energy required per transmitted bit summed over all the assigned carriers for the same achieved data rate.

Another metric that may be used is interference. The AT 2606 exploits frequency selective fading across assigned carriers to get multi-frequency diversity gain when possible by favoring power allocation to carriers with lower interference measured over a small time scale. The AT 2606 tries to maximize the number of bits transmitted per unit power by favoring power allocation (or first allocating power) to carriers with lower interference measured over a large time scale. Alternatively, the AT 2606 achieves interference efficient transmission by minimizing the transmit power for a given packet 524 size and termination target when possible by appropriately choosing the carriers.

The interference seen by the AT 2606 on each said assigned carrier may be indirectly measured by measuring a transmit pilot power or a reverse activity bit. These two metrics can be averaged over a time scale. The time scale determines the trade-off between reacting to noisy metrics due to lesser averaging, versus, reacting to overly smoothened metrics due to over filtering.

In another embodiment, the AT 2606 may rank all assigned carriers using a combination of metrics including, but not limited to, the metrics discussed above.

AT 2606 may decide to drop a carrier based on PA headroom, and maybe data considerations. In one embodiment, the AT 2606 chooses the carrier with highest TxPilotPower (averaged over some time period) to drop.

Transmitting across a number of assigned carriers in an E_{b}/N₀efficient mode comprises for the same total data rate of the access terminal, transmitting across a greater number of carriers using packet sizes for which the energy required per bit in the linear region is favored, as opposed to transmitting in a lesser number of carriers using packet sizes for which energy required per bit is in the non-linear (convex) region.

The MAC layer achieves load balancing across carriers with AN 2604-AT 2606 cooperation. The load balancing time scale can be broken down into two parts—short term load balancing and long term average load balancing. ATs 2606 achieve short term load balancing in a distributed manner by appropriately choosing amongst assigned carriers for transmissions on a per packet basis. Examples of short term load balancing include: i) The AT 2606 water fills power across all assigned carriers when RAB 1444 or packet 524 are size limited in every assigned carrier; and ii) The AT 2606 transmits over a subset of assigned carriers when power (i.e., PA headroom) limited.

The AN 2604 achieves long term load balancing by appropriately determining the MAC parameters for flows across carriers, and by appropriately allocating carriers to ATs 2606 in the time scale of active set management and new flow arrivals. The AN 2604 controls fairness and long term power allocation for each flow 2216 in the network across each assigned carrier by appropriately determining the MAC flow 2216 parameters as discussed above.

Carrier Allocation Using Grant Messages 2642

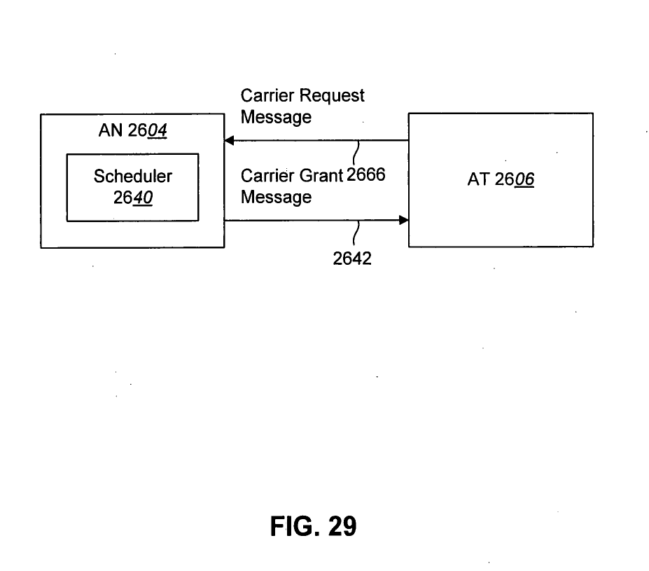

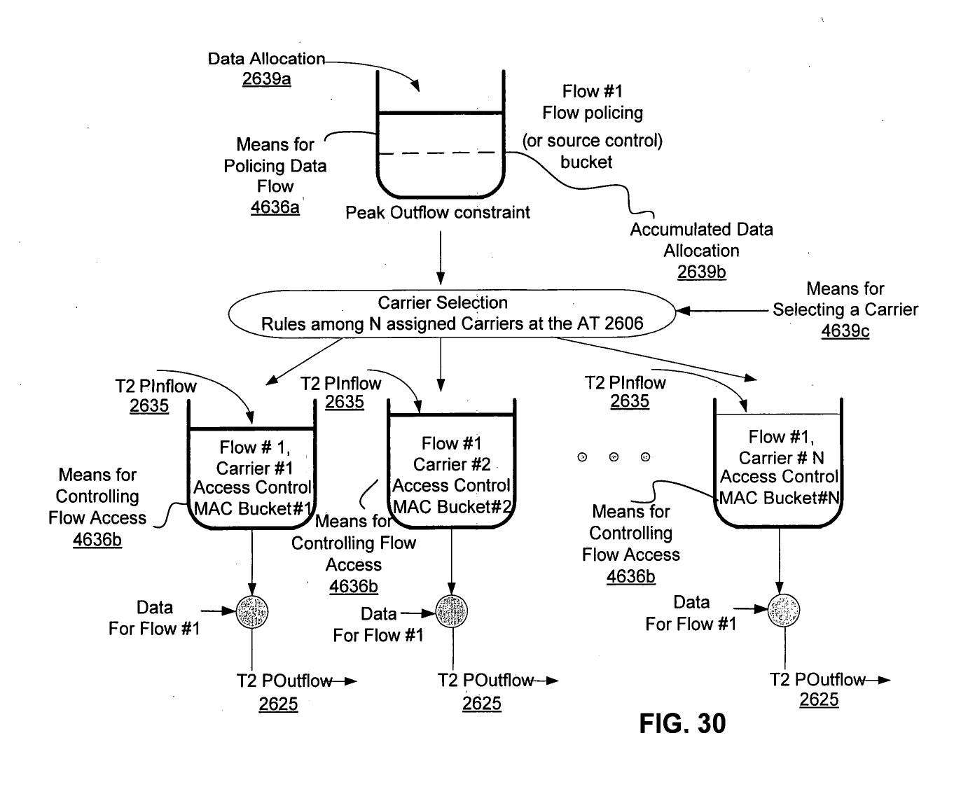

FIG. 29 illustrates an embodiment involving centralized control in which the AT 2606 sends a carrier request message 2666 to the scheduler 2640 on the AN 2604. FIG. 30 also illustrates the scheduler 2640 sending a carrier grant message 2642 to the AT 2606. The AN 2604 and AT 2606 may cooperate to find the best carrier allocation for the network using a message driven scheme. Similar to existing T2PInflow request-grant mechanism used in single carrier embodiments discussed earlier, the AT 2606 and AN 2604 use Carrier Request 2666 and Carrier Grant 2642 messages respectfully. In an AT 2606—driven mode, the AN 2604 relies on ATs 2606 requesting additional carriers when data and PA headroom justifies. In an AN 2604—driven mode, the AN 2604 may have all ATs 2606 periodically pass data, TxPilotPower, FL pilot strength and PA headroom information which the AN 2604 uses to when allocating carriers to ATs 2606. The Carrier Request 2666 and Carrier Grant 2642 messages can be asynchronous. AT 2606 may send a Carrier Request message 2666 to the AN 2604 for an increase/decrease in the number of carriers. Also, the AT 2606 can autonomously decrease the number of assigned carriers when the AT 2606 is link budget limited, but informs the AN 2604 after dropping a carrier. The AT 2606 sends a Carrier Request message 2666 to increase number of assigned carriers when data and PA headroom justify and decrease number of assigned carriers when PA headroom or data makes current number of carriers inefficient. The AT 2606 Carrier Request message 2666 may contain flow QoS requirements, average queue length, average TxPilotPower in each carrier, FL pilot strength in each carrier and PA headroom related information.

The AN 2604 may grant carriers based on AT 2606 request message information and load balancing FL overhead etc. criterions using the Carrier Grant message 2642. The AN 2604 may choose not to send a Carrier Grant message 2642 in response to a Carrier Request message 2666. The AN 2604 may increase/decrease/reassign the assigned carriers for each AT 2606 at any time using the Carrier Grant message 2642. Also, the AN 2604 may reassign carriers for each AT 2606 at any time to ensure load balancing and efficiency or based on FL requirements. The AN 2604 may decrease the number of carriers for each AT 2606 at any time. The AN 2604 may drop one carrier and assign another one for a given AT 2606 at any time—AT 2606 service is not interrupted when other carriers are enabled at the AT 2606 during the switching process. The ATs 2606 follow AN 2604 carrier grants 2642.

In one embodiment, the flow access control per carrier may be performed using priority functions. The per carrier allocation is similar to that used for single carrier systems and may be the same across all carriers. As the number of carriers assigned to a terminal changes, it is not required to change the RTC MAC bucket parameters.

As with the single carrier embodiments, the ramping rate on each carrier is limited by the maximum permissible interference.

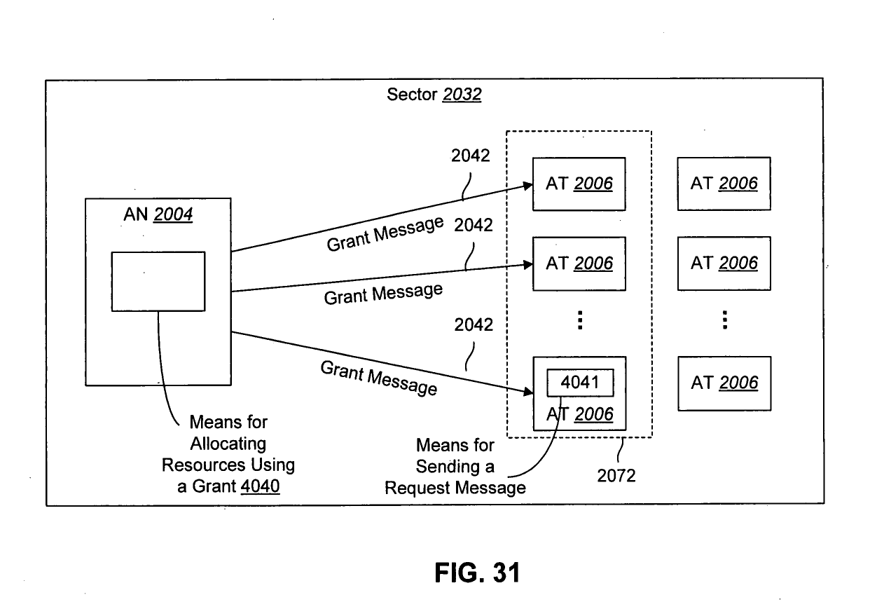

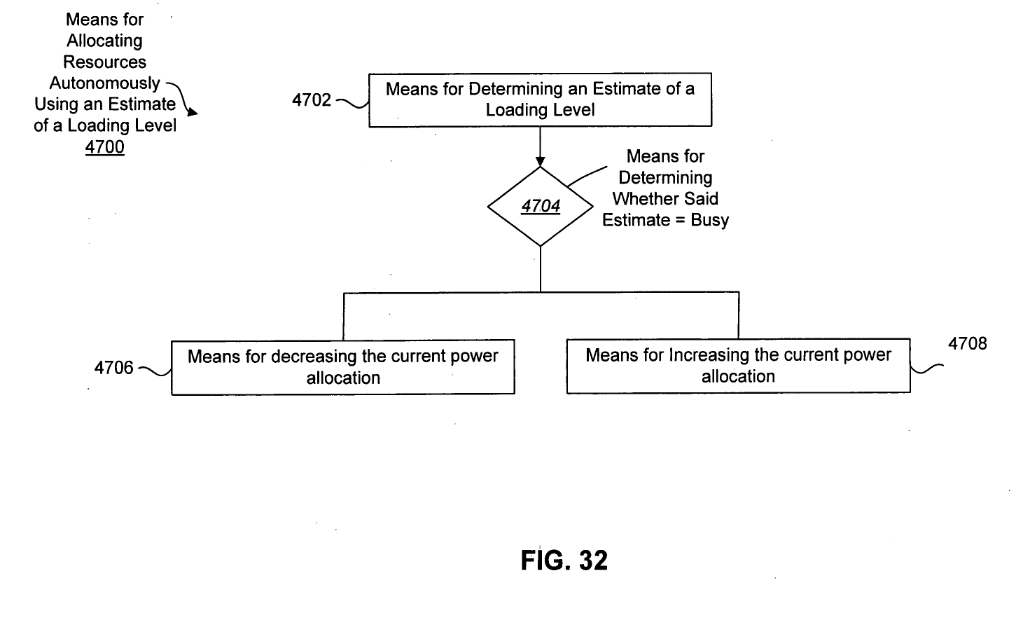

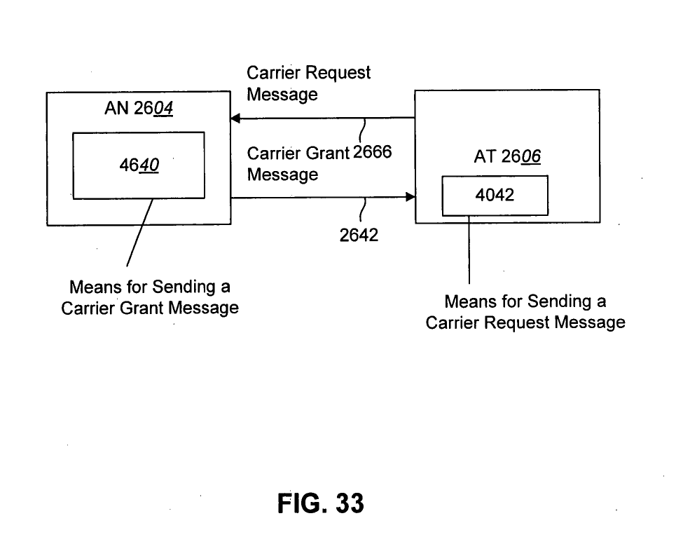

The methods and apparatuses of FIGS. 27, 20, 17 and 29 described above are performed by corresponding means plus function blocks illustrated in FIGS. 30-33 respectively. In other words, apparatuses 2636a, 2636b, and 2639c in FIG. 27 correspond to means plus function blocks 4636a, 4636b, and 4639c in FIG. 30. Apparatus 2040 in FIG. 20 is performed by corresponding means plus function block 4040 illustrated in FIG. 31. FIG. 31 also includes a means for sending a request message block 4041. Flowchart 1700 and steps 1702, 1704, 1706 and 1708 illustrated in FIG. 17 correspond to means plus function blocks 4700, 4702, 4704, 4706 and 4708 illustrated in FIG. 32. Apparatus 2640 in FIG. 29 is performed by corresponding means plus function block 4640 illustrated in FIG. 33. FIG. 33 also includes a means for sending a carrier request message block 4042.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of allocating resources among multiple flows transmitted across multiple carriers, comprising:
policing each data flow, whereby a peak data outflow constraint is applied for each flow across all assigned carriers;
selecting a carrier from a plurality of said assigned carriers for said data flow; and
controlling flow access, whereby a potential allowed transmission power for said data flow on said carrier is determined.

2. The method of allocating resources among the multiple flows according to claim 1, wherein said data flow is policed using a first bucket to shape traffic on a per flow basis and said flow access is controlled using a second bucket to shape transmit traffic channel power on a per flow and per carrier basis.

3. The method of allocating-resources among multiple flows transmitted across multiple carriers according to claim 1, wherein said step of policing data flow comprises:
allocating resources among multiple flows by determining a total available power for each flow, wherein said total available power includes a current power allocation for said flow and at least a portion of an accumulated power allocation for said flow.

4. The method of allocating resources among multiple flows transmitted across multiple carriers according to claim 1, wherein said step of controlling flow access comprises allocating resources using a grant.

5. The method of allocating resources among multiple flows transmitted across multiple carriers according to claim 1, wherein said step of controlling flow access comprises a step of allocating resources autonomously for each flow in each said assigned carrier.

6. The method of allocating resources among multiple flows transmitted across multiple carriers according to claim 1, wherein said step of selecting a carrier for said data flow comprises:
ranking said assigned carriers using a metric; and
allocating packets to said assigned carriers.

7. The method of allocating resources among multiple flows transmitted across multiple carriers according to claim 1, wherein said step of selecting a carrier for said data flow comprises:
water-filling power across all said assigned carriers when not data or power limited; and
transmitting across a subset of said assigned carriers when data or power limited.

8. The method of allocating resources among multiple flows transmitted across, multiple carriers according to claim 1, wherein said step of selecting a carrier for said data flow comprises:
transmitting across a number of said assigned carriers in an E_{b}/N₀efficient-mode.

9. The method of allocating resources among multiple flows transmitted across multiple carriers according to claim 1, wherein said step of selecting a carrier for said data flow comprises:
sending a carrier request message, whereby a number of said carriers may be increased.

10. The method of allocating resources among multiple flows transmitted across multiple carriers according to claim 1, wherein said step of selecting a carrier for said data flow comprises:
sending a carrier grant message, whereby an access node may increase, decrease or reassign said carrier.

11. The method according to claim 4, wherein said step of allocating flow resources using a grant comprises:
receiving a grant message; and
setting said current power allocation for a corresponding said flow equal to a current power allocation grant in said grant message.

12. The method of allocating resources among multiple flows transmitted across multiple carriers according to claim 4, further comprising:
determining MAC parameters for said flows across said carriers; and
allocating said carriers to arriving of said flows in an access terminal's active set sectors, whereby said access terminal achieves long term load balancing.

13. The method of allocating resources among multiple flows transmitted across multiple carriers according to claim 5, further comprising:
determining MAC parameters for said flows across said carriers; and
allocating said carriers to arriving of said flows in an access terminal's active set sectors, whereby said access terminal achieves long term load balancing.

14. The method according to claim 5, wherein said step of allocating resources autonomously comprise using an estimate of a loading level to allocate resources.

15. The method of allocating resources among multiple flows transmitted across multiple carriers according to claim 6, wherein said metric comprises an average pilot transmit power in each said assigned carrier, or a filtered reverse activity bit in each said assigned carrier, or a combination of both said average transmit pilot power and said filtered reverse activity bit in each said assigned carrier.

16. The method of allocating resources among multiple flows transmitted across multiple carriers according to claim 6, wherein said step of ranking assigned carriers using a metric further comprises maximizing a number of bits transmitted per unit power by first allocating power to said carriers with lower interference.

17. The method of allocating resources among multiple flows transmitted across multiple carriers according to claim 6, wherein said step of ranking assigned carriers using a metric further comprises indirectly measuring an interference seen by an access terminal on each said assigned carrier by measuring a transmit pilot power or a reverse activity bit.

18. The method of allocating resources among multiple flows transmitted across multiple carriers according to claim 6, further comprising allocating said packets on a per packet basis, whereby an access terminal achieves short term load balancing.

19. The method of allocating resources among multiple flows transmitted across multiple carriers according to claim 9, further comprising sending a carrier grant message, whereby an access node may increase, decrease or reassign assigned carriers.

20. The method of allocating resources among multiple flows transmitted across multiple carriers according to claim 9, wherein said carrier request comprises flow requirements, queue length and power headroom information.

21. The method according to claim 11, further comprising a step of sending a request message when a request interval increases above a threshold value.

22. The method according to claim 11, further comprising a step of sending a request message when a request ratio decreases below a certain threshold value.

23. The method according to claim 11, further comprising determining said grant for a subset of access terminals, wherein said grant includes a current power allocation grant.

24. The method according to claim 11, wherein said grant message includes a holding period for at least one said current power allocation grant and an accumulated power allocation grant for some at least one said flow.

25. The method according to claim 14, wherein said step of autonomously using an estimate of a loading level to determine a current power allocation for a flow comprises:
determining a value of said estimate associated with said flow;
determining whether said estimate is equal to a busy value;
decreasing said current power allocation if said estimate is equal to a busy value; and
increasing said current power allocation if said estimate is equal to an idle value.

26. The method according to claim 23, further comprising determining current power allocations for said access terminals not part of said subset of access terminals autonomously.

27. The method according to claim 23, wherein said current power allocation grant include an estimate of a steady-state value for said current power allocation for at least one said flow for at least one of said access terminals.

28. The method according to claim 25, further comprising:
calculating a magnitude of a decrease of said current power allocation using a downward ramping function; and
calculating a magnitude of an increase using an upward ramping function.

29. A communication element comprising a MAC layer that is configured for wireless communication, comprising:
a transmitter;
a receiver operably connected to said transmitter;
a processor operably connected to said transmitter and said transmitter; and
memory operably connected to said processor, wherein said access terminal is adapted to execute instructions stored in said memory comprising:
policing each data flow, whereby a peak data outflow constraint is applied for each flow across all assigned carriers;
selecting a carrier from a plurality of said assigned carriers for said data flow; and
controlling flow access, whereby a potential allowed transmission power for said data flow on said carrier is determined.

30. The communication element according to claim 29, wherein said data flow is policed using a first bucket to shape traffic on a per flow basis and said flow access is controlled using a second bucket to shape transmit traffic channel power on a per flow and per carrier basis.

31. The communication element according to claim 29, wherein said policing data flow instruction comprises:
allocating resources among multiple flows by determining a total available power for each flow, wherein said total available power includes a current power allocation for said flow and at least a portion of an accumulated power allocation for said flow.

32. The communication element according to claim 29, further comprising a scheduler adapted to allocate resources using a grant, wherein said instruction for controlling flow access comprises an instruction for allocating resources using a grant.

33. The communication element according to claim 29, wherein said instruction for controlling flow access comprises allocating resources autonomously for each flow in each said assigned carrier.

34. The communication element according to claim 29, wherein said instruction for selecting a carrier for said data flow comprises:
ranking said assigned carriers using a metric; and
allocating packets to said assigned carriers.

35. The communication element according to claim 29, wherein said step of selecting a carrier for said data flow comprises:
water-filling power across all assigned carriers when not data or power limited; and
transmitting across a subset of assigned carriers when data or power limited.

36. The communication element according to claim 29, wherein said step of selecting a carrier for said data flow comprises:
transmitting across a number of assigned carriers in an E_{b}/N₀efficient mode.

37. The communication element according to claim 29, wherein said instruction for selecting a carrier for said data flow comprises:
sending a carrier request message, whereby a number of said carrier may be increased.

38. The communication element according to claim 29, wherein said instruction for selecting a carrier for said data flow comprises further comprises an instruction for sending a carrier grant message, whereby an access node may increase, decrease or reassign said carrier.

39. The communication element according to claim 32, wherein said instruction for allocating flow resources using a grant comprises:
receiving a grant message; and
setting said current power allocation for a corresponding said flow equal to a current power allocation grant in said grant message.

40. The communication element according to claim 32, further comprising:
determining MAC parameters for said flows across said carriers; and
allocating said carriers to arriving of said flows in said communication elements's active set sectors, whereby said communication element achieves long term load balancing.

41. The communication element according to claim 33, further comprising:
determining MAC parameters for said flows across said carriers; and
allocating said carriers to arriving of said flows in said communication element's active set sectors, whereby said communication element achieves long term load balancing.

42. The communication element according to claim 33, wherein said instruction for allocating resources autonomously comprises using an estimate of a loading level to allocate resources.

43. The communication element according to claim 34, wherein said metric comprises an average pilot transmit power in each said assigned carrier, or a filtered reverse activity bit in each said assigned carrier, or a combination of both said average transmit pilot power and said filtered reverse activity bit in each said assigned carrier.

44. The communication element according to claim 34, wherein said step of ranking assigned carriers using a metric further comprises maximizing a number of bits transmitted per unit power by first allocating power to said carriers with lower interference.

45. The communication element according to claim 34, wherein said step of ranking assigned carriers using a metric further comprises indirectly measuring an interference seen by the communication element on each said assigned carrier by measuring a transmit pilot power or a reverse activity bit.

46. The communication element according to claim 34, further comprising allocating said packets on a per packet basis, whereby the communication element achieves short term load balancing.

47. The communication element according to claim 37, further comprising an instruction for sending a carrier grant message, whereby an access node may increase, decrease or reassign said assigned carriers.

48. The communication element according to claim 37, wherein said carrier request comprises flow requirements, queue length and power headroom information.

49. The communication element according to claim 39, further comprising an instruction for sending a request message when a request interval increases above a threshold value.

50. The communication element according to claim 39, further comprising an instruction for sending a request message when a request ratio decreases-below a certain threshold value.

51. The communication element according to claim 39, further comprising an instruction for determining said grant for a subset of said communication elements, wherein said grant includes a current power allocation grant.

52. The communication element according to claim 39, wherein said grant message includes a holding period for at least one said current power allocation grant and an accumulated power allocation grant for some at least one said flow.

53. The communication element according to claim 42, wherein said instruction for autonomously using an estimate of a loading level to determine a current power allocation for a flow comprises:
determining a value of said estimate associated with said flow;
determining whether said estimate is equal to a busy value;
decreasing said current power allocation if said estimate is equal to a busy value; and
increasing said current power allocation if said estimate is equal to an idle value.

54. The communication element according to claim 51, further comprising an instruction for determining current power allocations for said communication elements not part of said subset of communication elements autonomously.

55. The communication element according to claim 51, wherein said current power allocation grant includes an estimate of a steady-state value for said current power allocation for at least one said flow for at least one of said communication elements.

56. The communication element according to claim 53, further comprising the following instructions:
calculating a magnitude of a decrease of said current power allocation using a downward ramping function; and
calculating a magnitude of an increase using an upward ramping function.

57. A means for allocating resources among multiple flows transmitted across multiple carriers, comprising:
means for policing each data flow, whereby a peak data outflow constraint is applied for each flow across all assigned carriers;
means for selecting a carrier from a plurality of said assigned carriers for said data flow; and
means for controlling flow access, whereby a potential allowed transmission power for said data flow on said carrier is determined.

58. The means for allocating resources among the multiple flows according to claim 57, wherein said data flow is policed using a first bucket to shape traffic on a per flow basis and said flow access is controlled using a second bucket to shape transmit traffic channel power on a per flow and per carrier basis.

59. The means for allocating resources among multiple flows transmitted across multiple carriers according to claim 57, wherein said means for policing data flow comprises:
means for allocating resources among multiple flows associated with at least one of said access terminal by determining a total available power for each flow, wherein said total available power includes a current power allocation for said flow and at least a portion of an accumulated power allocation for said flow.

60. The means for allocating resources among multiple flows transmitted across multiple carriers according to claim 57, wherein said means for controlling flow access comprises means for allocating resources using a grant.

61. The means for allocating resources among multiple flows transmitted across multiple carriers according to claim 57, wherein said means for controlling flow access comprises means for allocating resources autonomously for each said flow in each said assigned carrier.

62. The means for allocating resources among multiple flows transmitted across multiple carriers according to claim 57, wherein said means for selecting a carrier for said data flow comprises:
means for ranking said assigned carriers using a metric; and
means for allocating packets to said assigned carriers.

63. The means for allocating resources among multiple flows transmitted across multiple carriers according to claim 57, wherein said step of selecting a carrier for said data flow comprises:
water-filling power across all said assigned carriers when not data or power limited; and
transmitting across a subset of said assigned carriers when data or power limited.

64. The means for allocating resources among multiple flows transmitted across multiple carriers according to claim 57, wherein said step of selecting a carrier for said data flow comprises:
transmitting across a number of said assigned carriers in an E_{b}/N₀efficient mode.

65. The means for allocating resources among multiple flows transmitted across multiple carriers according to claim 57, wherein said means for selecting a carrier for said data flow comprises:
means for sending a carrier request message, whereby a number of said carrier may be increased.

66. The means for allocating resources among multiple flows transmitted across multiple carriers according to claim 57, wherein means for selecting a carrier for said data flow further comprises:
means for sending a carrier grant message, whereby an access node may increase, decrease or reassign said carrier.

67. The means for allocating resources among the multiple flows according to claim 60, wherein said allocating resources among the multiple flows allocating flow resources using a grant comprises:
means for receiving a grant message; and
means for setting said current power allocation for a corresponding said flow equal to a current power allocation grant in said grant message.

68. The means for allocating resources among multiple flows transmitted across multiple carriers according to claim 60, further comprising:
determining MAC parameters for said flows across said carriers; and
allocating said carriers to arriving of said flows in said means for allocating resources among multiple flows transmitted across multiple carriers's active set sectors, whereby said means for allocating resources among multiple flows transmitted across multiple carriers achieves long term load balancing.

69. The means for allocating resources among multiple flows transmitted across multiple carriers according to claim 61, further comprising:
determining MAC parameters for said flows across said carriers; and
allocating said carriers to arriving of said flows in said means for allocating resources among multiple flows transmitted across multiple carriers's active set sectors, whereby said means for allocating resources among multiple flows transmitted across multiple carriers achieves long term load balancing.

70. The means for allocating resources among the multiple flows according to claim 61, wherein said means for allocating resources autonomously comprise a means for using an estimate of a loading level to allocate resources.

71. The means for allocating resources among multiple flows transmitted across multiple carriers according to claim 62, wherein said metric comprises an average pilot transmit power in each assigned carrier, or a filtered reverse activity bit in each assigned carrier, or a combination of both said average transmit pilot power and said filtered reverse activity bit.

72. The means for allocating resources among multiple flows transmitted across multiple carriers according to claim 62, wherein said step of ranking assigned carriers using a metric further comprises maximizing a number of bits transmitted per unit power by first allocating power to said carriers with lower interference.

73. The means for allocating resources among multiple flows transmitted across multiple carriers according to claim 62, wherein said step of ranking assigned carriers using a metric further comprises indirectly measuring an interference seen by the access terminal on each said assigned carrier by measuring a transmit pilot power or a reverse activity bit.

74. The means for allocating resources among multiple flows transmitted across multiple carriers according to claim 62, further comprising allocating said packets on a per packet basis, whereby the means for allocating resources among multiple flows transmitted across multiple carriers achieves short term load balancing.

75. The means for allocating resources among multiple flows transmitted across multiple carriers according to claim 65, further comprising means for sending a carrier grant message, whereby an access node may increase, decrease or reassign assigned carriers.

76. The means for allocating resources among multiple flows transmitted across multiple carriers according to claim 65, wherein said carrier request comprises flow requirements, queue length and power headroom information.

77. The means for allocating resources among the multiple flows according to claim 67, further comprising a means for sending a request message when a request interval increases above a threshold value.

78. The means for allocating resources among the multiple flows according to claim 67, further comprising a means for sending a request message when a request ratio decreases below a certain threshold value.

79. The means for allocating resources among the multiple flows according to claim 67, further comprising means for determining said grant for a subset of means for allocating resources among multiple flows transmitted across multiple carriers, wherein said grant includes a current power allocation grant.

80. The means for allocating resources among the multiple flows according to claim 67, wherein said grant message includes a holding period for at least one said current power allocation grant and an accumulated power allocation grant for said at least one said flow.

81. The means for allocating resources among the multiple flows according to claim 68, wherein said means for autonomously using an estimate of a loading level to determine a current power allocation for a flow comprises:
means for determining a value of said estimate associated with said flow;
means for determining whether said estimate is equal to a busy value;
means for decreasing said current power allocation if said estimate is equal to a busy value; and
means for increasing said current power allocation if said estimate is equal to an idle value.

82. The means for allocating resources among the multiple flows according to claim 79, further comprising means for determining current power allocations for means for allocating resources among multiple flows transmitted across multiple carriers not part of said subset autonomously.

83. The means for allocating resources among the multiple flows according to claim 79, wherein said current power allocation grant includes an estimate of a steady-state value for said current power allocation for at least one said flow for at least one of said means for allocating resources among multiple flows transmitted across multiple carriers.

84. The means for allocating resources among the multiple flows according to claim 81, further comprising:
means for calculating a magnitude of a decrease of said current power allocation using a downward ramping function; and
means for calculating a magnitude of an increase using an upward ramping function.
